(19) United States
(12) Patent Application Publication
(10) Pub. No.: US 2021/0345611 A1
(43) Pub. Date: Nov. 11, 2021

(54) EXTENDED AND CONTINUOUS RELEASE COMPOSITIONS FOR PLANT HEALTH AND METHOD OF USE

(71) Applicant: Verdesian Life Sciences U.S., LLC, Cary, NC (US)

(72) Inventors: Jacob MAZO, Des Plaines, IL (US); Grigory Mazo, Des Plaines, IL (US); Amy Burton, Fuquay-Varina, NC (US)

(21) Appl. No.: 17/269,669

(22) PCT Filed: Aug. 27, 2019
(86) PCT No.: PCT/US2019/048340

§ 371 Date: Feb. 19, 2021

Related U.S. Application Data
(60) Provisional application No. 62/723,797, filed on Aug. 28, 2018.

(51) Int. Cl. A01N 43/36; A01N 25/08; A01N 37/04; A01N 37/18; A01N 25/34

(52) U.S. Cl. CPC A01N 43/36; A01N 25/08; A01N 25/34; A01N 37/18; A01N 37/04

(57) ABSTRACT

The subject matter described herein relates generally to compositions comprising an agriculturally active compound having at least one carboxylic acid moiety or salt thereof in combination with a corresponding ester of the acid for continuous and sustained release of the compound, and methods of using the compositions for improving plant properties.

### TECHNICAL FIELD

The subject matter described herein relates generally to compositions comprising extended and continuous release properties in the form of a free acid or salt thereof of an agriculturally active carboxylic acid containing compound in combination with an ester form of the compound, and methods of using the compositions for improving plant properties.

### BACKGROUND

The use of agriculturally active compounds has greatly enhanced agricultural productivity and yields. Rapid plant growth is desirable as it is an important factor in timing, harvesting and cost of production. As such, rapid plant growth and yield maximization economically important goals for many agricultural businesses that grow high-value crops.

Though productivity has increased, it has become apparent that there are limits to the amount of agriculturally active compounds that can be added to plants and that can be safely absorbed into the environment. With increased demands on agricultural productivity comes environmental and economic requirements. This is particularly true with regard to the use of agriculturally active compounds during production because of cost and safety. Efficiency of agriculturally active compounds is important because of the associated costs, and the possible impact of agriculturally active compounds on the environment and the health of humans and animals. There is a desire for reduction of the amount of agriculturally active compounds applied; yet, the need for ever-increasing production remains.

The timing and frequency of applying agriculturally active compounds to plants and soil is often burdensome. It would be beneficial to coincide the application with the metabolic needs of the plants. What is therefore needed and addressed by the subject matter described herein are compositions comprising agriculturally active compounds that have beneficial properties that are lacked in the art.

### BRIEF SUMMARY

In one aspect, the subject matter described herein is directed to a composition comprising an agriculturally active compound having at least one carboxylic acid moiety of Formulae I′ and I″, and an ester of the compound, wherein the ester is a compound selected from Formulae I, Ia, II, IIa, and an agriculturally acceptable carrier.

In one aspect, the subject matter described herein is directed to methods of improving plant properties by contacting the area adjacent to the plant with a composition comprising an agriculturally active compound having at least one carboxylic acid moiety of Formulae I′ and I″, and an ester of the compound, wherein the ester is a compound selected from Formulae I, Ia, II, IIa, and IV.

In one aspect, the subject matter described herein is directed to an article, the article comprises an agriculturally active compound having at least one carboxylic acid moiety of Formulae I′ and I″, and an ester of the compound, wherein the ester is a compound selected from Formulae I, Ia, II, IIa, and IV.

In one aspect, the subject matter described herein is directed to a composition comprising pyroglutamic acid and one or more esters of pyroglutamic acid of Formulae V, VI and/or VII, and an agriculturally acceptable carrier.

In one aspect, the subject matter described herein is directed to methods of increasing the concentration of prolines in the foliar tissue of a plant by contacting the area adjacent to the plant with a composition comprising pyroglutamic acid and one or more esters of pyroglutamic acid of Formulae V, VI and/or VII, and an agriculturally acceptable carrier.

In one aspect, the subject matter described herein is directed to methods of improving plant properties by contacting the area adjacent to the plant with a composition comprising pyroglutamic acid and one or more esters of pyroglutamic acid of Formulae V, VI and/or VII, and an agriculturally acceptable carrier.

In one aspect, the subject matter described herein is directed to an article, the article comprises a composition comprising an agriculturally active compound having at least one carboxylic acid moiety of Formulae I′ and I″, and an ester of the compound, wherein the ester is a compound selected from Formulae I, Ia, II, IIa, and IV, and the article has an engineered three-dimensional shape.

In one aspect, the subject matter described herein is directed to methods of preparing the compositions and articles.

These and other aspects are fully described below.

### BRIEF DESCRIPTION OF THE FIGURES

FIG. 1 is an FTIR showing loss of reactants and formation of an exemplary composition.

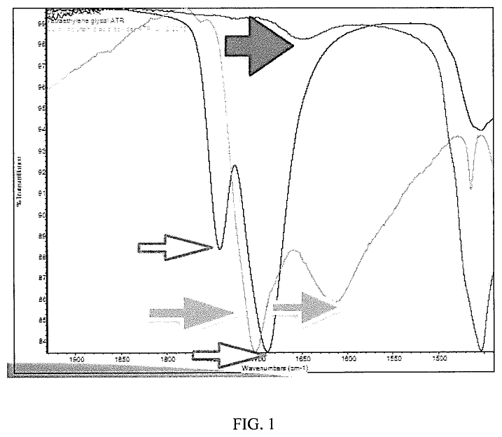

FIG. 2 shows agriculturally active compound (e.g., PGA) release kinetics of an exemplary composition at pH 7.75 (top), pH 6.75 (middle) and pH 5.75 (bottom).

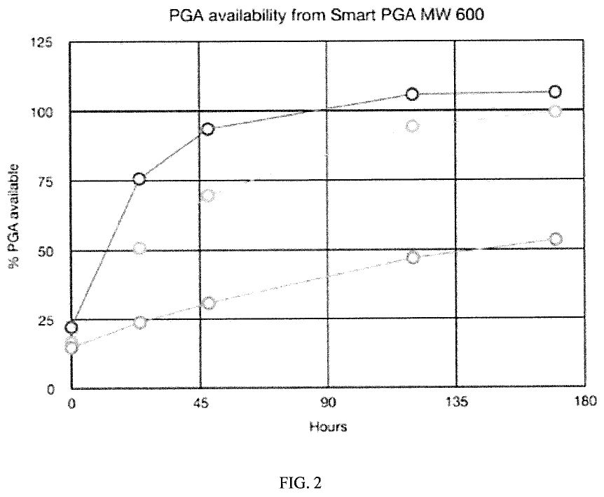

FIG. 3 shows agriculturally active compound (e.g., PGA) release kinetics of an exemplary composition at pH 7.75 (top), pH 6.75 (middle) and pH 5.75 (bottom).

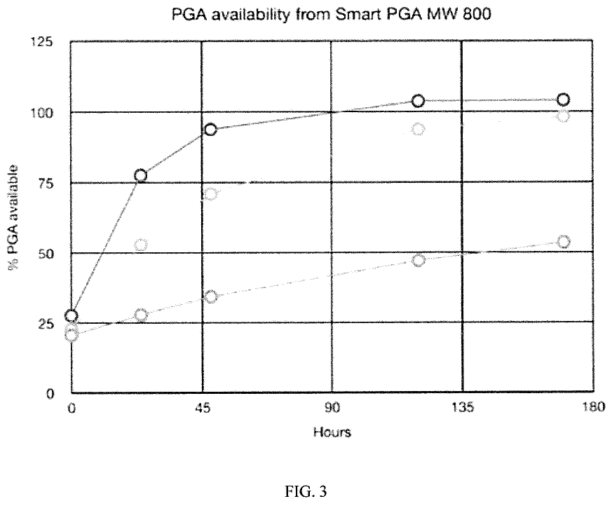

FIG. 4 shows agriculturally active compound (e.g., PGA) release kinetics of an exemplary composition at pH 7.75 (top), pH 6.75 (middle) and pH 5.75 (bottom).

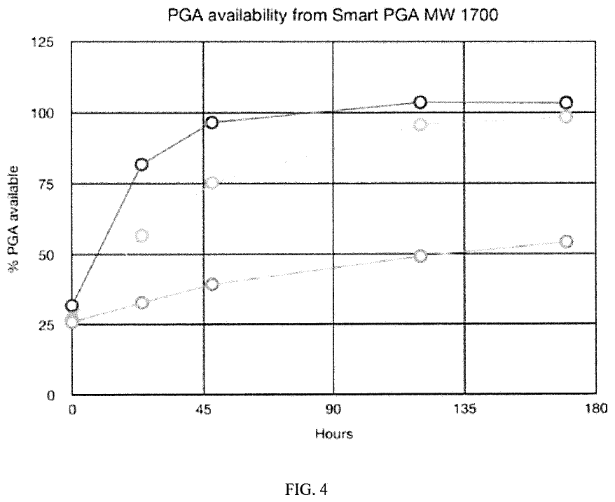

FIG. 5 shows a bar graph of dry weights (in grams) of four week old corn plants following an application of PGA ester compounds 1-4 at 50 or 100 g/acre using UTC as a standard.

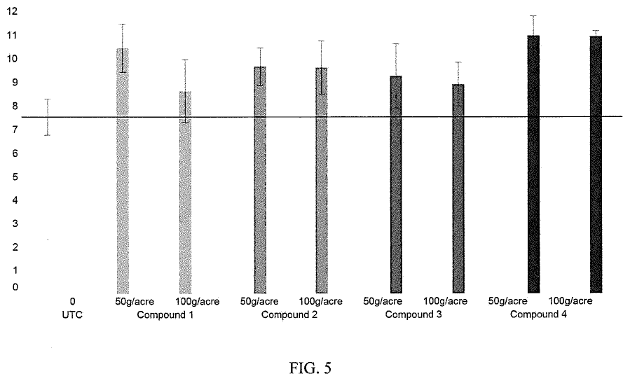

### DETAILED DESCRIPTION

The presently disclosed subject matter will now be described more fully hereinafter. However, many modifications and other embodiments of the presently disclosed subject matter set forth herein will come to mind to one skilled in the art to which the subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

Disclosed herein are compounds, compositions, and methods that advantageously provide desirable release profiles of agriculturally active compounds having at least one carboxylic acid, including compounds that have a toxophore that contains at least one carboxylic acid. Such agriculturally useful compounds include plant nutrients, herbicides, and fungicides. As described herein, it has now been found that certain water soluble esters of agriculturally active compounds provide for a beneficial continuous or extended release of the compound(s). Additionally, the rate of release can vary and can accommodate periods when the plant is actively growing and periods when the plant is less active. It has also been found that the esters must have certain stability properties whereby the composition is air stable, but provides a suitable rate of hydrolysis in the soil to provide the plant with nutrients. Described herein are such compositions.

An area in the art that needs improvement is the control of the rate of release of agriculturally active compounds once applied in the field. Decomposition occurs by various means, including but not limited to the action of soil microorganisms. As a result, it is historically more advantageous to perform a plurality of applications of compounds to growing plant(s) during a single season in order to produce a greater enhancing effect on the plant(s) being treated. However, these multiple applications result in additional labor and expense; it would be desirable to reduce the number of applications per season without compromising efficacy, if possible. The compositions and methods described herein provide that possibility.

In particular, the use of proline-related compounds, such as pyroglutamic acid (PGA) and/or its salts, are useful for productive agriculture. Certain compositions and methods are described in U.S. Pat. No. 6,831,040, which is incorporated herein by reference in its entirety. PGA is generally applied to plants in order to improve and enhance their growth. The applications can be made to plants' foliar and/or root parts. The application of PGA is generally to soil in proximity to plants that are growing, or to be germinated. PGA can be employed on its own, or more preferably as part of a formulated composition.

Another area for improvement is the physical form of known materials that are solids with a somewhat limited amount of solubility. More concentrated formulations in terms of active ingredient levels are often much more desirable for a variety of reasons well known to the art, such as ease of application, simplicity in handling, lower packaging and transport costs, etc. It is desirable that concentrations above those obtained heretofore be easily obtained. It is further desirable that the agriculturally active compound could be modified to be usable as a solvent in formulations lacking substantial amounts of water, thus rendering such formulations much more useful due to high actives concentration. Those skilled in the art of agriculturally useful composition formulation will appreciate the usefulness of this feature.

Yet another area for improvement is the timing aspect of application and effect. In certain embodiments, when the compounds described herein are applied to growing plants, with subsequent weather or other soil conditions adverse to rapid plant growth, the effect of the application on metabolism is not diminished. Adverse conditions, such as excessively low temperatures or insufficient water, are expected in agriculture. It is therefore desirable that release of the agriculturally active compound to plants occur in what might be termed a smart fashion, in the sense that release rate to plants is decreased at lower temperatures, and that the release rate is relatively higher when greater amounts of water are present. Those skilled in the art of plant metabolism research will appreciate the usefulness of regulating dosage to plant in this way as the combination of temperature and water content affect the growth of plants.

Described herein are compositions comprising an agriculturally active compound or salts thereof and a corresponding water soluble ester or salt thereof. The esters are formed from polyols and are advantageously water soluble. In the compositions, the amount of esters and the corresponding acids and/or salts can be controlled such that the composition can be tailored to contain specific amounts of each component and a pre-determined ratio of ester to acid or salt.

While some esters (monoesters, diesters, etc.) of PGA have been previously known to the art, they are not water soluble and/or were not used for applications related to productive agriculture. Further, art teaches the use of sufficiently pure esters, diesters, etc., substantially free of PGA. Black et al. in U.S. Pat. Nos. 4,774,255 and 5,190,980 disclose the use of PGA monoesters and methods of making same for the purposes of topical application to human skin in the context of cosmetics. Leinweber et al. in WO 2007/054225 disclose the making of PGA esters, diesters, etc., in pure form, and use of same as inhibitors of gas hydrate formation in various pipeline applications in the context of oil and gas industry. Among the diesters they teach are those with poly(ethylene glycol) (hereinafter, PEG) and other alcohol group containing molecules. These purported uses in cosmetics and/or petroleum industry would not appear to be fruitful avenues to pursue in the agricultural space.

Non-water soluble esters of ketosuccinimate are disclosed in WO 2017/217892. These esters are simple alkyl esters of alcohols and purport to have improved properties over ketosuccinimate.

Additionally, simple esters such as those in the art lack sufficient stability when exposed to air. Further, esters of tertiary alcohols may provide stability but do not provide desirable hydrolysis. As disclosed herein, there is a need for the compositions to be air stable and to hydrolyze at desirable rates. Unexpectedly, esterification of the agriculturally active compounds with the polyols described herein can provide these and other desirable properties. As disclosed herein, it has been found that certain water soluble polymers and block co-polymers provide the desirable release profile of agriculturally active compounds to the benefit of improving plant properties. These polymers and block co-polymers are derived from polyols having a primary or secondary hydroxyl group. The chemistry provides a tunable release of the agriculturally active compounds or salts thereof to improve plant properties.

### I. Definitions

As used herein, “plant” and “crop plant” includes cereals (such as wheat, barley, rye, triticale, sorghum/millet and oats), maize, soya, rice, potatoes, cotton, oilseed rape and fruit species (with the fruits apples, pears, citrus fruit and grapes) sunflower, bean, coffee, beet (for example sugar beet and fodder beet), peanut, oilseed rape, poppy, olive, coconut, cocoa, sugar cane, tobacco, vegetables (such as tomato, cucumbers, onions and lettuce), turf and ornamentals. Plants of interest include plant species grown for the purposes of providing animal nutrition, including but not limited to various grasses and leguminous plants known to the art of animal nutrition. Such plants may either be harvested in various ways known to the art and subsequently used for animal nutrition, or the plants may be consumed (in whole or in part) by animals while the plants are still growing, or while they are still attached to soil. Plants of interest also include any plant used in productive agriculture and needing a nitrogen nutrient supply as these plants would benefit from the compositions described herein. Transgenic plants are also included.

The term “plant health” describes for example, advantageous properties such as improved crop characteristics including, but not limited to better emergence, increased crop yields, more favorable protein and/or content, more favorable amino acid and/or oil composition, more developed root system (improved root growth), tillering increase, increase in plant height, bigger leaf blade, less dead basal leaves, stronger tillers, greener leaf color, pigment content, photosynthetic activity, less fertilizers needed, less seeds needed, more productive tillers, earlier flowering, early grain maturity, less plant verse (lodging), increased shoot growth, enhanced plant vigor, increased plant stand or early germination; or a combination of at least two or more of the aforementioned effects or any other advantages familiar to a person skilled in the art. Improved plant health can be determined by increased yield of plant product, improved plant vigor, enhanced quality of the plant and/or improved tolerance or resistance of the plant to abiotic and/or biotic stress factors.

As used herein, the term “water soluble” refers to a molecule, or mixture of molecules, capable of forming an aqueous solution that is stable for at least 1 hour at a solids concentration of at least 1% by weight, such as 1% to 4%, 5% to 10%, or 11 to 20% solids by weight (or at least 2%, 3%, 4%, 5%, 6%, 7%, 8%, 9%, 10%, 11%, 12%, 13%, 14%, 15%, 16%, 17%, 18%, or at least 19%). The solutions can be prepared by any means, such as ultrasound and high shear mixing. As used herein, the term “stable” refers to a solution that does not contain appreciable precipitation.

As used herein, the term “corresponding ester” refers to the ester of the specific plant nutrient.

By the term “contact” or “contacting” it is intended to allow the compositions and formulations to come in physical communication with the plant or its surroundings, such as the soil adjacent to or in the vicinity of the plant. Contacting can be by any conventional means.

The terms “residue” and “residue of a polyol” and the like refer to a molecule, for example a polyol, or a moiety, which has at least one hydrogen replaced with a covalent bond to another atom in a larger structure, such as those shown in Formulae I, Ia, II, IIa, IV, V, VI, VII, VIII, and IX. For example, an “O-A-O” and the like is a residue of a polyol A where at least two hydrogens from two hydroxyl groups on the polyol are each replaced with a covalent bond as described above; an “O-A-OH” and the like is a residue of a polyol A where at least one hydrogen from a hydroxyl group on the polyol is replaced with a covalent bond as described above and at least one hydroxyl is present on the residue as well; “A-O” and “A′-O” and the like are residues of a polyol A or polyol A′ where at least one hydrogen from a hydroxyl group on the polyol is replaced with a covalent bond as described above.

The term “toxophore” as used herein refers to a compound that in its active form has at least one carboxylic acid.

In the structures shown herein, where the stereochemistry of any particular chiral atom is not specified, then all stereoisomers are contemplated and included as the compounds of the currently disclosed subject matter. Where stereochemistry is specified by a solid wedge or dashed line representing a particular configuration, then that stereoisomer is so specified and defined. Unless otherwise specified, if solid wedges or dashed lines are used, relative stereochemistry is intended. If a discrepancy exists between a structure and its name, the structure governs. Stereochemical definitions and conventions used herein generally follow S. P. Parker, Ed., McGraw-Hill Dictionary of Chemical Terms (1984) McGraw-Hill Book Company, New York; and Eliel, E. and Wilen, S., “Stereochemistry of Organic Compounds”, John Wiley & Sons, Inc., New York, 1994. The compounds of the currently disclosed subject matter can contain asymmetric or chiral centers, and therefore exist in different stereoisomeric forms. It is intended that all stereoisomeric forms of the compounds of the currently disclosed subject matter, including but not limited to, diastereomers, enantiomers and atropisomers, as well as mixtures thereof such as racemic mixtures, form part of the present subject matter. Many organic compounds exist in optically active forms, i.e., they have the ability to rotate the plane of plane-polarized light. In describing an optically active compound, the prefixes D and L, or R and S, are used to denote the absolute configuration of the molecule about its chiral center(s). The prefixes d and l or (+) and (−) are employed to designate the sign of rotation of plane-polarized light by the compound, with (−) or l meaning that the compound is levorotatory. A compound prefixed with (+) or d is dextrorotatory. For a given chemical structure, these stereoisomers are identical except that they are mirror images of one another. A specific stereoisomer can also be referred to as an enantiomer, and a mixture of such isomers is often called an enantiomeric mixture. A 50:50 mixture of enantiomers is referred to as a racemic mixture or a racemate, which can occur where there has been no stereoselection or stereo specificity in a chemical reaction or process. The terms “racemic mixture” and “racemate” refer to an equimolar mixture of two enantiomeric species, devoid of optical activity.

As used herein, the term “chiral” refers to molecules which have the property of non-superimposability of the mirror image partner, while the term “achiral” refers to molecules which are superimposable on their mirror image partner.

As used herein, the term “stereoisomers” refers to compounds which have identical chemical constitution, but differ with regard to the arrangement of the atoms or groups in space.

“Diastereomer” refers to a stereoisomer with two or more centers of chirality and whose molecules are not mirror images of one another. Diastereomers have different physical properties, e.g., melting points, boiling points, spectral properties, and reactivities. Mixtures of diastereomers can separate under high resolution analytical procedures such as electrophoresis and chromatography.

“Enantiomers” refer to two stereoisomers of a compound which are non-superimposable mirror images of one another.

Additional definitions are set forth herein below.

### II. Compositions

In one aspect, the subject matter described herein is directed to a composition comprising:
i. an agriculturally active compound having at least one carboxylic acid moiety and having the formula:

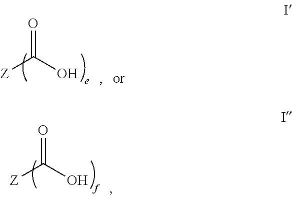

wherein, e and f are independently an integer from 1 to 4 or salts thereof;

and
ii. one or more esters of said agriculturally active compound, said ester selected from the group consisting of:

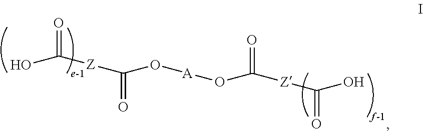

wherein, O-A-O is a residue of a first polyol;

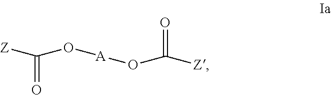

wherein, O-A-O is a residue of a first polyol;

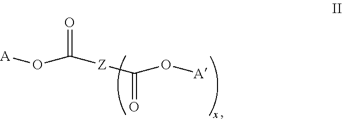

wherein,
   A-O is a residue of a first polyol;
   A′-O is a residue of a second polyol or a hydroxyl group; and
   x is an integer from 0 to 3;

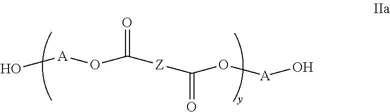

wherein,
   O-A-OH is a residue of a first polyol;
   y is an integer from 1 to 50; and

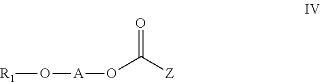

wherein,
   O-A-O is a residue of a polyol; and
   R₁ is absent or is selected from hydrogen and Q, wherein Q is Z′;

or salts thereof; and,
iii. an agriculturally acceptable carrier.

Agriculturally Active Compounds Having at Least One Carboxylic Acid Moiety

The agriculturally active compound having at least one carboxylic acid moiety is selected from the group consisting of carboxylic acid containing herbicides, carboxylic acid containing fungicides, pyroglutamic acid, levulinic acid, pamoic acid, ketosuccinamide, and dicarboxylic acids of Formula III, such as oxaloacetic acid, having the structure:

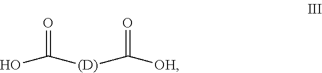

or salt thereof, wherein, D is an optionally substituted linear C₁₋₅ alkyl group having at least one carbonyl embedded in the alkyl group.

The compound can also be a derivative of a compound, such as a simple alkyl ester, wherein the compound itself has a toxophore that contains at least one carboxylic acid. The compounds are represented by Formulae I′ and I″, wherein Z and Z′ represent the portion of the chemical structure that is covalently bound to the at least one carboxylic acid moiety. In Formulae I′ and I″, the carboxylic acid moiety or moieties is/are represented by the —COOH, which moiety or moieties can be present one, two, three or four times in the compound as represented by the value of e or f, respectively.

In some embodiments, compounds of Formulae I′ and I″ are an herbicide. Exemplary herbicides include, but are not limited to, benzoic acid herbicides, pyrimidinyloxybenzoic acid herbicides, pyrimidinylthiobenzoic acid herbicides, picolinic acid herbicides, quinolinecarboxylic acid herbicides, phenoxyacetic and arylphenoxy propionic herbicides, phenoxybutyric herbicides, and phenoxypropionic herbicides and carboxylic acid analogs thereof and salts thereof.

In some embodiments, compounds of Formulae I′ and I″ are a benzoic acid herbicide selected from the group consisting of cambendichlor, chloramben, dicamba, 2,3,6-TBA and tricamba and carboxylic acid analogs and salts thereof.

In some embodiments, compounds I′ and I″ are a pyrimidinyloxybenzoic acid herbicide selected from the group consisting of bispyribac and pyriminobac.

In some embodiments, compounds I′ and I″ are a picolinic acid herbicide selected from the group consisting of aminopyralid, clopyralid, florpyrauxifen, halauxifen and picloram.

In some embodiments, compounds I′ and I″ are a quinolinecarboxylic acid herbicide selected from the group consisting of quinclorac and quinmerac.

In some embodiments, compounds I′ and I″ are a phenoxyacetic herbicide selected from the group consisting of clacyfos, 4-chlorophenoxyacetic acid (4-CPA), 2,4-dichlorophenoxy acetic acid (2,4-D), 3,4-dichlorophenoxy acetic acid (3,4-DA), 2-methyl-4-chlorophenoxyacetic acid (MCPA), S-ethyl (4-chloro-2-methylphenoxy)ethanethioate (MCPA-thioethyl), and 2,4,5-trichlorophenoxyacetic acid (2,4,5-T).

In some embodiments, compounds I′ and I″ are a phenoxybutyric herbicide selected from the group consisting of 4-chlorophenoxyacetic acid (4-CPB), 4-(2,4-dichlorophenoxy)butyric acid (2,4-DB), 4-(3,4-dichlorophenoxy)butyric acid (3,4-DB), 4-(2-methyl-4-chlorophenoxy)butyric acid (MCPB), and 4-(2,4,5-trichlorophenoxy)butyric acid (2,4,5-TB).

In some embodiments, compounds I′ and I″ are a phenoxypropionic herbicide selected from the group consisting of cloprop, 2-(4-chlorophenoxy)propionic acid (4-CPP), dichlorprop, dichlorprop-P, 2-(3,4-dichlorophenoxy)propionic acid (3,4-DP), fenoprop, mecoprop and mecoprop-P.

In some embodiments, compounds I′ and I″ are an aryloxyphenoxypropionic herbicide selected from the group consisting of chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, kuicaoxi, metamifop, propaquizafop, quizalofop, quizalofop-P, trifop and endothal.

In some embodiments, compounds I′ and I″ are a fungicide. Exemplary fungicides include, but are not limited to acylamino acid fungicides, antibiotic fungicides, methoxyacrylate strobilurin fungicides and carboxylic acid analogs thereof, and combinations thereof. In some embodiments, compounds I′ and II″ are an acylamino acid fungicide selected from the group consisting of benalaxyl, benalaxyl-M, furalaxyl, metalaxyl, metalaxyl-M, pefurazoate and valifenalate.

In some embodiments, compounds I′ and I″ are an antibiotic fungicide selected from the group consisting of blasticidin-S, kasugamycin, natamycin and polyoxorim.

In some embodiments, compounds I′ and II″ are a methoxyacrylate strobilurin fungicide and a carboxylic acid analog thereof selected from the group consisting of azoxystrobin, bifujunzhi, coumoxystrobin, enoxastrobin, flufenoxystrobin, jiaxiangjunzhi, picoxystrobin, pyraoxystrobin, cloquintocet, fenchlorazole, isoxadifen, mefenpyr and megatomoic acid.

Esters of Agriculturally Active Compounds Having at Least One Carboxylic Acid Moiety

The esters of Formulae I, Ia, II, IIa, and IV are prepared by esterifying a compound of Formula I′ or I″ with a polyol. Useful polyols contain more than one primary and/or secondary alcohol and are selected from the group consisting of tetraols, triols, diols, and polyalkylene glycols, and oligomers or dendrimers thereof. In some embodiments, the polyol is a polyalkylene glycol. In some embodiments, the polyalklylene glycol is linear or branched and is selected from polyethylene glycol and/or polypropylene glycol. In some embodiments, the polyol is a tetraol, such as pentaerythritol, including its dimers, trimers and oligomers. Also useful are dimers and trimers of pentaerythritol, such as dipentaerythritol and tripentaerythritol. In such embodiments, the polyol has a structure:

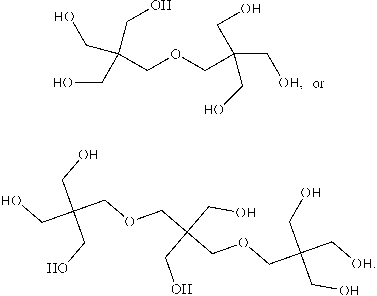 [SMILES: OCC(CO)(CO)COCC(CO)(CO)CO ; OCC(CO)(CO)COCC(CO)(CO)COCC(CO)(CO)CO]

Thus, a residue of such a polyol would have one or more hydrogens replaced with one or more covalent bonds as described elsewhere herein. In some embodiments, the number of hydrogen bonds that are being replaced are one, two, three four, or five bonds. In some embodiments, the polyol is a triol, such as trimethylolpropane, and its dimers, trimers and oligomers. In some embodiments, the polyol can be a non-cyclic saccharides having at least two, three, four, five, or six primary alcohol groups and at least four, five, six, seven, or eight carbons.

Polymers and oligomers containing more than one primary and/or secondary alcohol are useful; however, tertiary alcohols are not. In some embodiments, such polyols include polymers or oligomers of alkylene glycol(s), such as, But not limited to, polyethylene glycol (PEG) and/or polypropylene glycol (PPA). Use of such materials and related compounds provides resulting esters, diesters, etc., having desired water solubility that can be advantageously used in formulating agriculturally useful compositions.

A non-limiting example of a polyalkylene glycol having primary alcohol groups is PEG. By variation of the molecular weight of PEG polymers (or oligomers, tetramers, etc.) it is possible to vary the resulting ester and diester based compositions. For example, PGA ester compositions derived from lower molecular weight PEGs are advantageously liquids that are non-volatile at room temperature. As another example, PGA ester compositions derived from sufficiently high molecular weight PEGs can be a solid that melts at desired temperatures, e.g., between about 40 and 60° C. Among preferred molecules for use as moieties that contain more than one primary alcohol group available for ester formation are polyalkylene glycols that are linear or branched. Polyalkylene glycols with a molecular weight of from about 150 Da to about 10,000 Da are useful, or from about 80 Da to about 8,000 Da or from about 350 Da to about 8,000 Da. In some embodiments, the polyalkylene glycols are linear, possess two primary hydroxyl groups as end groups, and have a number average molecular weight of between about 300 Da and about 5,000 Da. In some embodiments, the polyalkylene glycols are linear, possess two primary hydroxyl groups as end groups, and have a number average molecular weight of between about 350 Da and about 3,500 Da. In some embodiments, the polyalkylene glycols are linear, possess two primary hydroxyl groups as end groups, and have a number average molecular weight of between about 600 Da and about 1,700 Da. Among these types of polymers are PEGs. Common PEG molecular weights and exemplary corresponding diesters described herein are shown below, although the currently disclosed subject matter is not limited thereto.

| | | MW | moles —OH | g PGA added | PGA content | |
|---|---|---|---|---|---|---|
| | MW (PEG), | (diester), | per 100 g | per 100 g PEG | of finished | |
| Compounds | approx . . . | approx. | PEG, approx . . . | (equimolar) | product* | Notes |
| 1 | 400 | 600 | 0.500 | 64.555 | 41.502% | slightly |
| | | | | | | viscous liquid |
| 2 | 600 | 800 | 0.333 | 43.037 | 31.406% | viscous liquid |
| 3 | 1000 | 1200 | 0.200 | 25.822 | 21.128% | low T |
| | | | | | | meltable solid** |
| 4 | 1500 | 1750 | 0.133 | 17.215 | 14.994% | meltable solid |
| | 33500 | 3550 | 0.060 | 7.708 | 7.229% | meltable solid |

*present as both free PGA and diester, assumes 100% release of PGA from diester
**Calc.

A non-limiting example of a polyalkylene glycol having secondary alcohol groups is polypropylene glycol (PPG). The use of a secondary alcohol to form an ester in the polymer or co-polymer of Formulae I, Ia, II, IIa, and IV can affect the rate of release of the agriculturally active compound I′ and I″. The ester formed from the secondary alcohol can have a slower hydrolysis rate as compared to the ester of a primary alcohol. In some embodiments, the hydrolysis rate of the ester formed from the secondary alcohol is at least about 1%, 5%, 10%, 20%, 25%, 30%, 35%, 40%, 45%, or at least 50% slower compared to the ester of the primary alcohol. As a result, the formation of the free acid of the plant nutrient can be slowed and extended. In some embodiments, the formation of the free acid of the plant nutrient is slowed by at least about 1%, 5%, 10%, 20%, 25%, 30%, 35%, 40%, 45%, or at least 50%. In some embodiments, the formation of the free acid of the plant nutrient is extended by at least about 1%, 5%, 10%, 20%, 25%, 30%, 35%, 40%, 45%, or at least 50%. In some embodiments, the PPG is a linear PPG that provides two terminal secondary alcohol groups per molecule. In some embodiments, the PPG is a branched PPG that provides, e.g., a tri-terminal PPG (PT-700 polyol). In aspects, the resulting ester from the polyol has a molecular weight of 100, 200, 300, 400, 500, 600, 700, 800, 900, or 1,000 Daltons or above. Use of the tri-terminal PPG affords a relatively higher amount of the agriculturally active compound relative to the weight of the polyol. Also useful are PPGs that are liquids at room temperature.

Compositions can comprise esters derived from primary alcohols and esters derived from secondary alcohols. The release rate and other desirable properties can be tuned by modulating the ratio of esters derived from primary alcohols to esters derived from secondary. Thus, the ratio can be pre-determined. In some embodiments, this ratio of esters derived from primary to secondary alcohols ranges from about 1,000:1 to about 1:1,000. In some embodiments, the ratio of esters derived from primary to secondary alcohols is about 1,000:1, or 500:1, or 250:1, or 100:1, or 50:1, or 20:1, or 10:1, or 5:1 or 2:1, or 1:1, or 1:2, or 1:5, or 1:10, or 1:20, or 1:50, or 1:100, or 1:250, or 1:500. By variation of the ratio of esters derived from primary alcohols to esters derived from secondary alcohols, the release rate of the composition can be tuned. Further, the physical properties of the composition can be modulated by varying the ratio in a pre-determined manner.

In some embodiments, the first polyol and the second polyol are the same type of polyol, e.g., PEG. In some embodiments, in Formulae I, Ia, II, IIa, and IV the first polyol is PEG or a copolymer thereof and the second polyol is PEG or a copolymer thereof or a hydroxyl group. In some embodiments, the first polyol and the second polyol are different types of polyols, e.g., PEG and PPG. In certain aspects, the composition further comprises an ester of said agriculturally active compound, said ester having the formula:

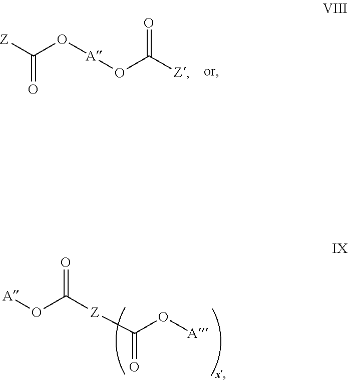

wherein, O-A″-O and A″-O are each a residue of a polyalkylene glycol other than polyethylene glycol (PEG); O-A′″ is a residue of a polyalkylene glycol other than polyethylene glycol (PEG); and x′ is 0 or 1.

In some embodiments comprising two or more esters, each derived from a different polyol than the other, the ratio of I and/or II to VIII and/or IX is about 0.1:10 to about 10:0.1; or the ratio of I and/or II to VIII and/or IX is about 1:10 to about 10:1; or the ratio of I and/or II to VIII and/or IX is about 1:5 to about 5:1; or the ratio of I and/or II to VIII and/or IX is about 1:2 to about 2:1.

In aspects, the compositions comprise mixed esters. Mixed esters include an agriculturally active compound and an ester of the agriculturally active compound, and a second agriculturally active compound and an ester of the second agriculturally active compound. In further embodiments, the compositions can contain three or more agriculturally active compounds and esters thereof.

In aspects, the ester of the composition is water soluble. In aspects, the composition including the agriculturally active compound having at least one carboxylic acid moiety and the ester is water soluble.

In aspects, the ester of the composition has a weight average molecular weight of about 200 Da or above, or 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, 9100, 9200, 9300, 9400, 9500, 9600, 9700, 9800, or 9900 Da or above. In aspects, the ester of the composition has a weight average molecular weight of about 200 Da to about 10,000 Da. In aspects, the ester of the composition has a weight average molecular weight of about 300 Da to about 10,000 Da, or from about 300 Da to about 5,000 Da. In aspects, the ester of the composition has a weight average molecular weight of about 310 Da to about 9,000 Da. In aspects, the ester of the composition has a weight average molecular weight of about 320 Da to about 8,000 Da. In aspects, the ester of the composition has a weight average molecular weight of about 330 Da to about 7,000 Da. In aspects, the ester of the composition has a weight average molecular weight of about 340 Da to about 6,000 Da. In aspects, the ester of the composition has a weight average molecular weight of about 350 Da to about 5,000 Da, or from about 350 Da to about 3,500 Da. In aspects, the ester of the composition has a weight average molecular weight of about 600 Da to about 1,700 Da.

In one aspect, the subject matter described herein is directed to a composition comprising a plant nutrient selected from the group consisting of pyroglutamic acid, levulinic acid, pamoic acid and ketosuccinimate, or a salt thereof, and a corresponding ester of Formulae I, Ia, II, IIa, and IV, and optionally an agriculturally acceptable carrier. The compositions comprise: pyroglutamic acid or a salt thereof and the product of an esterification between pyroglutamic acid and a polyol; or levulinic acid or a salt thereof and the product of an esterification between levulinic acid and a polyol; or pamoic acid or a salt thereof and the product of an esterification between pamoic acid and a polyol; or ketosuccinimate or a salt thereof and the product of an esterification between ketosuccinimate and a polyol; or a dicarboxylic acid of Formula III or a salt thereof and the product of an esterification between the dicarboxylic acid of Formula III and a polyol.

In some embodiments, the composition comprises:
i. said agriculturally active compound I′ is pyroglutamic acid having the structure:

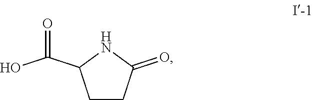

or salts thereof, and said ester of said agriculturally active compound is an ester of Formula IV:

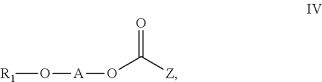

wherein,
   O-A-O is a residue of a first polyol;
   Z is

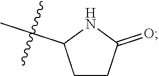 [SMILES: *C1CCC(=O)N1]

and
R₁ is absent or is selected from the group consisting of hydrogen and Q;
wherein, Q is Q¹ and has the structure:

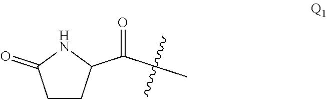

wherein,

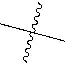

is the point of attachment;
ii. said agriculturally active compound is levulinic acid having the structure:

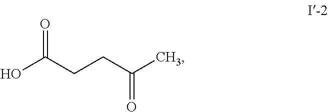

or salts thereof, and said ester of said agriculturally active compound is an ester of Formula IV:

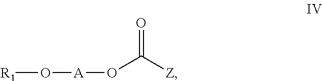

wherein,
   O-A-O is a residue of a first polyol;
   Z is

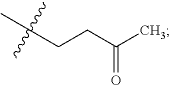 [SMILES: *CCC(C)=O]

and
R₁ is independently selected from the group consisting of hydrogen and Q;
wherein, Q is Q² and has the structure:

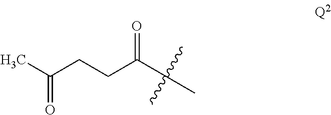

wherein,

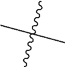

is the point of attachment;

or
iii. said agriculturally active compound is ketosuccinimate having the structure:

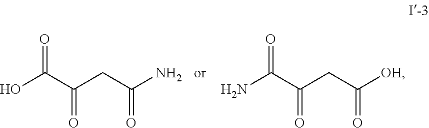 [SMILES: NC(=O)CC(=O)C(=O)O ; NC(=O)C(=O)CC(=O)O]

or salts thereof, and said ester of said agriculturally active compound is an ester of Formula IV:

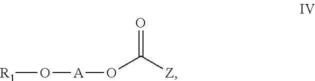

wherein,
   O-A-O is a residue of a first polyol;
   Z is

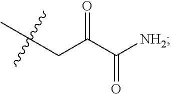 [SMILES: *CC(=O)C(N)=O]

R₁ is independently selected from the group consisting of hydrogen and Q;
wherein, Q is Q³ and has the structure:

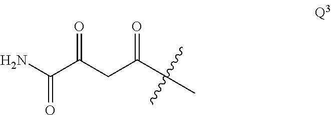

wherein,

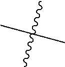

is the point of attachment;
and an agriculturally acceptable carrier.

In some embodiments, the composition comprises an agriculturally active compound I′ that is pyroglutamic acid or salts thereof, and one or more esters of pyroglutamic acid and an agriculturally acceptable carrier, wherein the ester(s) is selected from the group consisting of Formulae V-VII:

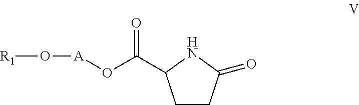

or salts thereof, wherein,

O-A-O is a residue of a linear or branched polyalkylene glycol or oligomer or dendrimer thereof, and R₁ is absent or is selected from the group consisting of hydrogen and Q¹;

the polyol is pentaerythritol and the ester is of Formula VI:

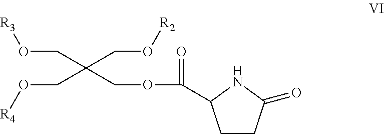

or salts thereof, wherein,

R₂, R₃ and R₄, in each instance, is independently selected from the group consisting of hydrogen and Q¹;

the polyol is trimethylpropane and the ester is of Formula VII:

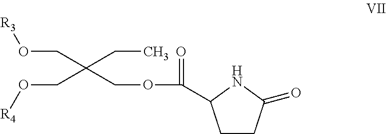

or salt thereof, wherein,

R₃ and R₄, in each instance, is independently selected from the group consisting of hydrogen and Q¹.

In embodiments, the composition comprises an agriculturally active compound I′ that is pyroglutamic acid or salts thereof, and one or more esters of pyroglutamic acid and an agriculturally acceptable carrier, wherein the ester(s) is of Formula Va:

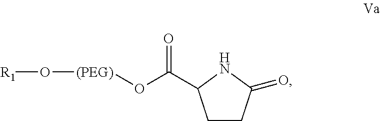

wherein, O-PEG-O is a residue of PEG; and R¹ is hydrogen or Q¹.

In embodiments, the combination compositions comprise:

i. an agriculturally active compound I′ or I″ that is:
g. a dicarboxylic acid having the structure:

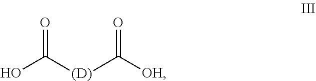

or salt thereof, wherein, D is an optionally substituted linear C₁₋₅ alkyl group having at least one carbonyl embedded in the alkyl group;

ii. a corresponding ester of Formulae I, Ia, II, IIa, and IV, and optionally

iii. an agriculturally acceptable carrier.

In certain aspects, D is

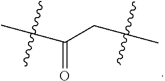 [SMILES: *CC(*)=O]

In embodiments, the composition comprises an agriculturally active compound I′ or I″ that is oxaloacetic acid or salts thereof, and one or more esters of oxaloacetic acid and an agriculturally acceptable carrier, wherein the ester(s) is of Formula IIa′:

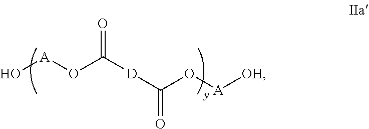

wherein, D is

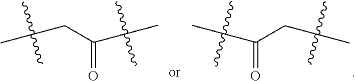 [SMILES: *CC(*)=O ; *CC(*)=O]

In certain aspects, in Formula IIa′, O-A and O-A-OH, in each instance, is a residue of a polyalkylene glycol. In certain aspects, in Formula IIa′, O-A and O-A-OH, in each instance, can be a residue of a different polyalkylene glycol. In certain aspects, in Formula IIa′, O-A and O-A-OH, in each instance, is a residue of tetraethylene glycol. In certain aspects, in Formula IIa′, A, in each instance, has the structure:

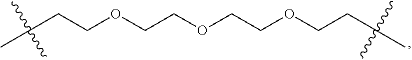 [SMILES: *CCOCCOCCOCC*]

and y is an integer from 1 to 50; or 2 to 45; or 3 to 40; or 4 to 35; or 5 to 30; or 10 to 25; or 15 to 20. In certain aspects, y is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50.

In some embodiments, the combination comprises a mixture of esters of Formulae V and VI; Formulae VI and VII; and Formulae V, VI and VII.

In embodiments, the compositions comprise from about 0.1% to about 100% agriculturally active compound having at least one carboxylic acid or salt thereof, and the corresponding ester. In some embodiments, the compositions comprise from about 0.1% to about 100% pyroglutamic acid or salt thereof, levulinic acid or salt thereof, or ketosuccinimate or salt thereof, and the corresponding ester. In some embodiments, the compositions comprise from about 1% to about 100% agriculturally active compound having at least one carboxylic acid or salt thereof, and the corresponding ester. In some embodiments, the compositions comprise from about 1% to about 100% pyroglutamic acid or salt thereof, levulinic acid or salt thereof, or ketosuccinimate or salt thereof, and the corresponding ester. In some embodiments, the compositions comprise from about 10% to about 90% agriculturally active compound having at least one carboxylic acid or salt thereof, and the corresponding ester. In some embodiments, the compositions comprise from about 10% to about 90% pyroglutamic acid or salt thereof, levulinic acid or salt thereof, or ketosuccinimate or salt thereof, and the corresponding ester. In some embodiments, the compositions comprise from about 20% to about 80% agriculturally active compound having at least one carboxylic acid or salt thereof, and the corresponding ester. In some embodiments, the compositions comprise from about 20% to about 80% pyroglutamic acid or salt thereof, levulinic acid or salt thereof, or ketosuccinimate or salt thereof, and the corresponding ester. In some embodiments, the compositions comprise from about 30% to about 70% agriculturally active compound having at least one carboxylic acid or salt thereof, and the corresponding ester. In some embodiments, the compositions comprise from about 30% to about 70% pyroglutamic acid or salt thereof, levulinic acid or salt thereof, or ketosuccinimate or salt thereof, and the corresponding ester. In some embodiments, the compositions comprises at least about 10%, 20%, 30%, 40%, 50%, 60%, 70%, 80%, or 90% of the agriculturally active ester compounds having at least one carboxylic acid or salt thereof, and the corresponding ester.

In embodiments, the agriculturally active compound having at least one carboxylic acid or salt thereof is present in an amount from about 1% to about 90% by mole based on the total (i.e., combined) number of moles of the agriculturally active compound having at least one carboxylic acid or salt thereof, and the corresponding ester. In some embodiments, the pyroglutamic acid or salt thereof, levulinic acid or salt thereof, or ketosuccinimate or salt thereof, is present in an amount from about 1% to about 90% by mole based on the total (i.e., combined) number of moles of the pyroglutamic acid or salt thereof, levulinic acid or salt thereof or ketosuccinimate or salt thereof, and the corresponding ester. In some embodiments, the agriculturally active compound having at least one carboxylic acid or salt thereof is present in an amount from about 2% to about 80% by mole based on the total (i.e., combined) number of the agriculturally active compound having at least one carboxylic acid or salt thereof, and the corresponding ester. In some embodiments, the pyroglutamic acid or salt thereof, levulinic acid or salt thereof, or ketosuccinimate or salt thereof, is present in an amount from about 2% to about 80% by mole based on the total (i.e., combined) number of the pyroglutamic acid or salt thereof, levulinic acid or salt thereof or ketosuccinimate or salt thereof, and the corresponding ester. In some embodiments, the agriculturally active compound having at least one carboxylic acid or salt thereof is present in an amount from about 3% to about 50% by mole based on the total (i.e., combined) number of the agriculturally active compound having at least one carboxylic acid or salt thereof, and the corresponding ester. In some embodiments, the pyroglutamic acid or salt thereof, levulinic acid or salt thereof, or ketosuccinimate or salt thereof, is present in an amount from about 3% to about 50% by mole based on the total (i.e., combined) number of the pyroglutamic acid or salt thereof, levulinic acid or salt thereof or ketosuccinimate or salt thereof, and the corresponding ester. In some embodiments, the agriculturally active compound having at least one carboxylic acid or salt thereof is present in an amount from about 5% to about 40% by mole of the total moles of the agriculturally active compound having at least one carboxylic acid or salt thereof, and the corresponding ester. In some embodiments, the pyroglutamic acid or salt thereof, levulinic acid or salt thereof, or ketosuccinimate or salt thereof, is present in an amount from about 5% to about 40% based on the total (i.e., combined) number of the pyroglutamic acid or salt thereof, levulinic acid or salt thereof or ketosuccinimate or salt thereof, and the corresponding ester. In some embodiments, the agriculturally active compound having at least one carboxylic acid or salt thereof is present in an amount from about 10% to about 30% based on the total (i.e., combined) number of the agriculturally active compound having at least one carboxylic acid or salt thereof, and the corresponding ester. In some embodiments, the pyroglutamic acid or salt thereof, levulinic acid or salt thereof, or ketosuccinimate or salt thereof, is present in an amount from about 10% to about 30% by mole based on the total (i.e., combined) number of the pyroglutamic acid or salt thereof, levulinic acid or salt thereof or ketosuccinimate or salt thereof, and the corresponding ester. In some embodiments, the agriculturally active compound having at least one carboxylic acid or salt thereof is present in an amount from about 15% to about 20% by mole based on the total (i.e., combined) number of the agriculturally active compound having at least one carboxylic acid or salt thereof, and the corresponding ester. In some embodiments, the pyroglutamic acid or salt thereof, levulinic acid or salt thereof, or ketosuccinimate or salt thereof, is present in an amount from about 15% to about 20% by mole based on the total (i.e., combined) number of the pyroglutamic acid or salt thereof, levulinic acid or salt thereof or ketosuccinimate or salt thereof, and the corresponding ester. In some embodiments, the pyroglutamic acid or salt thereof is present in an amount from about 10% to about 30% based on the total (i.e., combined) number of the pyroglutamic acid and the ester of pyroglutamic acid. In some embodiments, the pyroglutamic acid or salt thereof is present in an amount from about 15% to about 20% by mole based on the total (i.e., combined) number of the pyroglutamic acid and the ester of pyroglutamic acid. In some embodiments, the agriculturally active compound having at least one carboxylic acid or salt thereof is present in an amount of at least about 10%, 20%, 30%, 40%, 50%, 60%, 70&, 80%, 90%, or at least 90% by mole based on the total (i.e., combined) number of the agriculturally active compound having at least one carboylic acid or salt thereof.

The amount of ester, diester, 25rimester, etc., can be varied to a pre-determined ratio. When present, R₁, R₂, R₃, and R₄, are each independently hydrogen or Q (Q¹, Q² or Q³). When present and R₁, R₂, R₃, or R₄, is hydrogen, when combined with the adjacent oxygen, there is a free hydroxyl, and when present and R₁, R₂, R₃, or R₄, is Q (Q¹, Q² or Q³), when combined with the adjacent oxygen, there is an ester. In some embodiments, from about 10% to about 90% of available R₁, R₂, R₃, and R₄ is Q (Q¹, Q² or Q³), and the remainder of available R₁, R₂, R₃, and R₄ is hydrogen. In some embodiments, from about 20% to about 80% of available R₁, R₂, R₃, and R₄ is Q (Q¹, Q² or Q³), and the remainder of available R₁, R₂, R₃, and R₄ is hydrogen. In some embodiments, from about 30% to about 70% of available R₁, R₂, R₃, and R₄ is Q (Q¹, Q² or Q³), and the remainder of available R₁, R₂, R₃, and R₄ is hydrogen. In some embodiments, from about 40% to about 60% of available R₁, R₂, R₃, and R₄ is Q (Q¹, Q² or Q³), and the remainder of available R₁, R₂, R₃, and R₄ is hydrogen. In some embodiments, at least about 10%, 20%, 30%, 40%, 50%, 60%, 70%, 80%, or at least 90% of available R₁, R₂, R₃, and R₄ is Q (Q¹, Q² or Q³), and the remainder of available R₁, R₂, R₃, and R₄ is hydrogen.

Degradation of the ester moieties by hydrolysis once applied to a plant or area adjacent to a plant can be varied. This results in a variable rate of release of the agriculturally active compound or salt thereof into the plant or the area adjacent to a plant. Advantageously, at relatively higher temperatures and moisture content, the release can be more rapid, whereas in lower temperatures or dry conditions, the release rate can be significantly decreased. Such properties are advantageous since plant growth at relatively low temperatures is expected to be at a relatively lower in rate, and thus the amount of nutrient need by the plant and provided by the compositions is lower. As temperatures rise, the release rate of the plant nutrient from the compositions can increase to accommodate plant metabolism and growth. Similarly, under conditions of low water availability, plant growth is lower and thus the release rate of the plant nutrient is lower as well. Under conditions of higher water availability, plant growth is more rapid, and the release rate of the plant nutrient from the composition would be higher. The result can be described as an extended or continuous release.

In embodiments, from about 50% to about 100% of the ester(s) of Formulae I, Ia, II, IIa, and IV is hydrolyzed over a period of about 50 days or less after the composition is contacted with a plant or area adjacent to the plant. In some embodiments, from about 50% to about 100% of the pyroglutamic acid ester(s) or the levulinic acid ester(s) or the ketosuccinimate ester(s) or the pamoic acid ester(s) or the ketosuccinamide ester(s) or the ester(s) of dicarboxylic acid(s) of Formula III is hydrolyzed over a period of about 50 days or less after the composition is contacted with the plant or area adjacent to the plant. In some embodiments, from about 50% to about 100% of the ester(s) of Formulae I, Ia, II, IIa, and IV is hydrolyzed over a period of about 30 days or less after the composition is contacted with a plant or area adjacent to the plant. In some embodiments, from about 50% to about 100% of the pyroglutamic acid ester(s) or the levulinic acid ester(s) or the ketosuccinimate ester(s) or the pamoic acid ester(s) or the ketosuccinamide ester(s) or the ester(s) of dicarboxylic acid(s) of Formula III is hydrolyzed over a period of about 30 days or less after the composition is contacted with the plant or area adjacent to the plant. In some embodiments, from about 50% to about 100% of the ester(s) of Formulae I, Ia, II, IIa, and IV is hydrolyzed over a period of about 10 days or less after the composition is contacted with a plant or area adjacent to the plant. In some embodiments, from about 50% to about 100% of the pyroglutamic acid ester(s) or the levulinic acid ester(s) or the ketosuccinimate ester(s) or the pamoic acid ester(s) or the ketosuccinamide ester(s) or the ester(s) of dicarboxylic acid(s) of Formula III is hydrolyzed over a period of about 10 days or less after the composition is contacted with the plant or area adjacent to the plant. In some embodiments, from about 100% of the ester(s) of Formulae I, Ia, II, IIa, and IV is hydrolyzed over a period of about 40 days or less after the composition is contacted with a plant or area adjacent to the plant. In some embodiments, about 100% of the pyroglutamic acid ester(s) or the levulinic acid ester(s) or the ketosuccinimate ester(s) or the pamoic acid ester(s) or the ketosuccinamide ester(s) or the ester(s) of dicarboxylic acid(s) of Formula III is hydrolyzed over a period of about 40 days or less after the composition is contacted with the plant or area adjacent to the plant. In embodiments, from about 50% to about 100% of the ester(s) of Formulae I, Ia, II, IIa, and IV is hydrolyzed over a period of about 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2 or 1 day(s) or less after the composition is contacted with the plant or area adjacent to the plant.

In embodiments, the agriculturally active compound having at least one carboxylic acid moiety is released from the composition over a period of about 50 days or less after the composition is contacted with the plant or area adjacent to the plant. In some embodiments, the pyroglutamic acid or the levulinic acid or the ketosuccinimate or the pamoic acid or the ketosuccinamide or the dicarboxylic acid(s) of Formula III is released from the composition over a period of about 50 days or less after the composition is contacted with the plant or area adjacent to the plant. In some embodiments, the agriculturally active compound having at least one carboxylic acid moiety is released from the composition over a period of about 40 days or less after the composition is contacted with the plant or area adjacent to the plant. In some embodiments, the pyroglutamic acid or the levulinic acid or the ketosuccinimate or the pamoic acid or the ketosuccinamide or the dicarboxylic acid(s) of Formula III is released from the composition over a period of about 40 days or less after the composition is contacted with the plant or area adjacent to the plant. In some embodiments, the agriculturally active compound having at least one carboxylic acid moiety, the pyroglutamic acid or the levulinic acid or the ketosuccinimate or the pamoic acid or the ketosuccinamide or the dicarboxylic acid(s) of Formula III is released from the composition over a period of about 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2 or 1 day(s) or less after the composition is contacted with the plant or area adjacent to the plant.

The release rate can be tailored to pH values generally found in the soil. That is, the release rates disclosed herein can be tailored to and associated with pH values from 4.0 to 9.0, or 5.0 to 8.0, such as 5.00, 5.25, 5.50, 5.75, 6.00, 6.25, 6.50, 6.75, 7.00, 7.25, 7.50, 7.75 and 8.00. Further, the release rate is in the presence of air, which is necessary for field use and is a shortcoming of other esters that are not air stable.

The release rate also can be tailored to the temperature generally found in soil. That is, the release rates disclosed herein can be tailored to and associated with temperature values from about 0° C. to about 45° C., about 5° C. to about 40° C., about 8° to about 35° C., about 10 to about 30° C., about 15° C. to about 25°, or about 18° C. to about 23° C. (or at about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, or 45° C.). Further, the release rate is in the presence of air, which is necessary for field use and is a shortcoming of other esters that are not air stable.

The stability agriculturally active compound and/or ester thereof can be tailored to the moisture content and/or pH and or temperature generally present in the soil. That is, the stability of the agriculturally active compound and/or ester thereof is at least 50%, 55%, 60%, 65%, 70%, 75%, 80%, 85%, 90%, or 95% over a given time frame. In some embodiments, the time frame is 1-50 days, 1-40 days, 1-30 days, 1-20 days, or 1-10 days (or 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 days).

In one aspect, the composition comprises pyroglutamic acid (PGA; pyroglutamate) or a salt thereof and the product of an esterification between pyroglutamic acid and a polyol. In some embodiments, the subject matter described herein is directed to a composition comprising pyroglutamic acid and one or more esters of pyroglutamic acid of Formula I or II, and optionally an agriculturally acceptable carrier. Pyroglutamic acid has the following stereochemical structures:

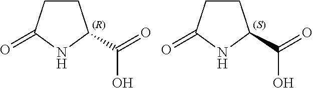

Pyroglutamic acid exists in two forms, the D and L stereoisomers. As such, pyroglutamic acid can be present in the combination products as D or L or a ratio of D:L, including racemic, as set forth elsewhere herein. Derivatives of pyroglutamic acid includes its salts. The neutral salt is the preferred derivative. Salts include, but are not limited to, sodium, potassium, amines, ammonium, calcium and magnesium. Hydrates are also included.

Embodiments of the compositions include those where the pyroglutamic acid is stereochemically enhanced or purified. The commercially available pyroglutamate, synthesized by a bacterial fermentation process, has a stereochemistry ratio of approximately 60:40 of the L isomer to the D isomer. In some embodiments, the compositions described herein contain L and D isomers of pyroglutamate in various ratios and contribute to the efficacy of such compositions in promoting seed germination, plant growth and yield, and resistance to stresses. In some embodiments, such compositions are also useful as seed germination mediums and can be employed in a seed coat for enhancing seed germination. The isomer ratio can be varied. In some embodiments, the pyroglutamic acid is L-pyroglutamic acid. In some embodiments, the pyroglutamic acid is a mixture of L- and D-pyroglutamic acid. In these embodiments, the ratio of L to D is from about 80:20 to about 97:3. In some embodiments, the amount of L isomer present is greater than the amount of D isomer. It has been found that the isomers of PGA can be conserved during esterification process by control over the process of the reaction. Stereoisomers and ratios are included as well as described elsewhere herein.

In one aspect, the composition comprises levulinic acid or a salt thereof and the product of an esterification between levulinic acid and a polyol. Levulinic acid has the following structure:

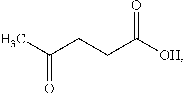

or salts thereof.

In one aspect, the composition comprises ketosuccinimate or a salt thereof and the product of an esterification between levulinic acid and a polyol. Ketosuccinimate has the following structure:

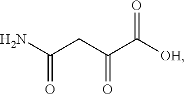

or salts thereof.

The composition's physical form can depend on the molecular structure and molecular size/weight of the polyol part of the molecule. Those skilled in the art of chemical synthesis and structure-property relationship determination can understand how to vary the molecular structure and weight of the hydroxyl-carrying reagent to obtain desired state (liquid, solid, higher or lower melting point, and greater or lesser viscosity) of the composition desired. The compositions described herein can be formulated in any useful formulation.

### III. Formulations

Formulations of the compositions described herein can be in any useful form. Depending on their desired physical and/or chemical properties, formulations can be in the form of liquids, solids, suspensions, granules, ready-to-use solutions, powders, emulsifiable concentrates, macrogranules, microgranules, pastes, and suspension concentrates. For purposes of the present disclosure, “ready-to-use” refers to compositions that are not in a concentrate form but rather which may be applied without modification of the relative amounts of components within the product.

The physical form of the formulations can be made as liquids of suitable viscosity at room temperature and pressure. They can be used as a combination of solvent and active ingredient in a variety of formulations of agricultural utility. In some embodiments, the formulation comprises solvents for delivering high concentrations of active ingredient(s) in a substantially water-free, or relatively low water content formulation. This enables formulation with ingredients of agricultural utility that are not stable with respect to long-term water exposure.

The physical form of the formulations can be made as solids at room temperature and pressure. In one aspect, the compositions taught herein can be made as solids with a sufficiently high melting point to be usable as solid objects of multifarious shapes, such as prills, sticks, rods, etc., yet the melting point can be controlled by selecting suitable molecular structures to be sufficiently low to make the production of such objects by casting, extrusion, and similar methods well known to the art of polymer object production relatively easy without excessive temperatures required.

Formulations include any materials suitable for practicing productive agriculture that are applied to, or in vicinity of, plants, in order to enhance their growth and/or productivity by supplying nutrients to the plants, in combination with composition comprising a plant nutrient selected from the group consisting of pyroglutamic acid, levulinic acid, and ketosuccinimate, or a salt thereof, and a corresponding ester of Formula I, and optionally an agriculturally acceptable carrier. These include, but are not limited to, various fertilizers containing macronutrients, micronutrients, mixtures thereof, and irrigation materials containing water and other ingredients, enzyme inhibitors, metabolic pathway regulators, etc. The fertilizers can be any materials known to the art of productive agriculture, including fertilizers containing nitrogen.

Formulations can contain solvents. Suitable organic solvents include all polar and non-polar organic solvents usually employed for formulation purposes. Preferable the solvents are selected from ketones, e.g., methyl-isobutyl-ketone and cyclohexanone, amides, e.g., dimethyl formamide and alkanecarboxylic acid amides, e.g., N,N-dimethyl decaneamide and N,N-dimethyl octanamide, furthermore cyclic solvents, e.g., N-methyl-pyrrolidone, N-octyl-pyrrolidone, N-dodecylpyrrolidone, N-octyl-caprolactame, N-dodecyl-caprolactame and butyrolactone, furthermore strong polar solvents, e.g., dimethylsulfoxide, and aromatic hydrocarbons, e.g., xylol, Solvesso™, mineral oils, e.g., white spirit, petroleum, alkyl benzenes and spindle oil, also esters, e.g., propyleneglycol-monomethylether acetate, adipic acid dibutylester, acetic acid hexylester, acetic acid heptylester, citric acid tri-n-butylester and phthalic acid di-n-butylester, and also alcohols, e.g., benzyl alcohol and 1-methoxy-2-propanol. Useful liquid solvents are essentially: aromatics such as xylene, toluene or alkylnaphthalenes, chlorinated aromatics and chlorinated aliphatic hydrocarbons such as chlorobenzenes, chloroethylenes or dichloromethane, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, and also water.

Formulations can include carriers and fillers. A carrier is a natural or synthetic, organic or inorganic substance for admixing or combining with the compositions for better applicability, in particular for application to plants or plant parts or seed. The carrier, which may be solid or liquid, is generally inert and should be suitable for use in agriculture. Useful solid or liquid carriers include, but are not limited to: for example ammonium salts and natural rock dusts, such as kaolins, clays, talc, chalk, quartz, attapulgite, montmorillonite or diatomaceous earth, and synthetic rock dusts, such as finely divided silica, alumina and natural or synthetic silicates, resins, waxes, solid fertilizers, water, alcohols, especially butanol, organic solvents, mineral and vegetable oils, and derivatives thereof. Mixtures of such carriers can likewise be used.

Suitable solid filler and carrier include inorganic particles, e.g., carbonates, silicates, sulphates and oxides with an average particle size of between 0.005 and 20 μm, 0.05 and 15 μm, or between 0.02 to 10 μm, for example ammonium sulphate, ammonium phosphate, urea, calcium carbonate, calcium sulphate, magnesium sulphate, magnesium oxide, aluminum oxide, silicium dioxide, so-called fine-particle silica, silica gels, natural or synthetic silicates, and alumosilicates and plant products like cereal flour, wood powder/sawdust and cellulose powder.

Useful solid carriers include, but are not limited to: for example crushed and fractionated natural rocks such as calcite, marble, pumice, sepiolite, dolomite, and synthetic granules of inorganic and organic meals, and also granules of organic material such as sawdust, coconut shells, maize cobs and tobacco stalks.

Formulations can include other additional components, for example protective colloids, binders, extenders, adhesives, tackifiers, thickeners, thixotropic substances, penetrants, stabilizers, sequestrants, surfactants, complexing agents, etc. In general, the compositions can be combined with any solid or liquid additive commonly used for formulation purposes.

In the formulations, it is possible to use tackifiers such as carboxymethylcellulose, and natural and synthetic polymers in the form of powders, granules or lattices, such as gum arabic, polyvinyl alcohol and polyvinyl acetate, or else natural phospholipids, such as cephalins and lecithins, and synthetic phospholipids. Further additives may be mineral and vegetable oils. If the extender used is water, it is also possible to employ, for example, organic solvents as auxiliary solvents.

The formulations may additionally comprise surfactants. Useful surfactants are emulsifiers and/or foam formers, dispersants or wetting agents having ionic or nonionic properties, or mixtures of these surfactants. Examples of these are salts of polyacrylic acid, salts of lignosulphonic acid, salts of phenolsulphonic acid or naphthalenesulphonic acid, polycondensates of ethylene oxide with fatty alcohols or with fatty acids or with fatty amines, substituted phenols (preferably alkylphenols or arylphenols), salts of sulphosuccinic esters, taurine derivatives (preferably alkyl taurates), phosphoric esters of polyethoxylated alcohols or phenols, fatty esters of polyols, and derivatives of the compounds containing sulphates, sulphonates and phosphates, for example alkylaryl polyglycol ethers, alkylsulphonates, alkylsulphates, arylsulphonates, protein hydrolysates, lignosulphite waste liquors and methylcellulose. The presence of a surfactant is necessary if one of the active ingredients and/or one of the inert carriers is insoluble in water and when application is effected in water. The proportion of surfactants is between 1 to 50 percent, 5 and 40 percent, or 10 to 30 percent by weight (or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, or 49%) of the inventive composition.

Suitable surfactants (adjuvants, emulsifiers, dispersants, protective colloids, wetting agent and adhesive) include all common ionic and non-ionic substances, for example ethoxylated nonylphenols, polyalkylene glycolether of linear or branched alcohols, reaction products of alkyl phenols with ethylene oxide and/or propylene oxide, reaction products of fatty acid amines with ethylene oxide and/or propylene oxide, furthermore fatty acid esters, alkyl sulfonates, alkyl sulphates, alkyl ethersulphates, alkyl etherphosphates, arylsulphate, ethoxylated arylalkylphenols, e.g., tristyryl-phenol-ethoxylates, furthermore ethoxylated and propoxylated arylalkylphenols like sulphated or phosphated arylalkylphenol-ethoxylates and -ethoxy- and -propoxylates. Further examples are natural and synthetic, water soluble polymers, e.g., lignosulphonates, gelatine, gum arabic, phospholipides, starch, hydrophobic modified starch and cellulose derivatives, in particular cellulose ester and cellulose ether, further polyvinyl alcohol, polyvinyl acetate, polyvinyl pyrrolidone, polyacrylic acid, polymethacrylic acid and co-polymerisates of (meth)acrylic acid and (meth)acrylic acid esters, and further co-polymerisates of methacrylic acid and methacrylic acid esters which are neutralized with alkalimetal hydroxide and also condensation products of optionally substituted naphthalene sulfonic acid salts with formaldehyde.

The formulations may comprise colorants and dyes. Dyes include, but are not limited to, inorganic pigments, for example iron oxide, titanium oxide and Prussian Blue, and organic dyes such as alizarin dyes, azo dyes and metal phthalocyanine dyes, and trace nutrients such as salts of iron, manganese, boron, copper, cobalt, molybdenum and zinc.

Antifoams which may be present in the formulations include, but are not limited to, e.g., silicone emulsions, long-chain alcohols, fatty acids and their salts as well as fluoroorganic substances and mixtures thereof.

Thickeners include polysaccharides, e.g., xanthan gum or veegum, silicates, e.g., attapulgite, bentonite as well as fine-particle silica.

The amounts of plant nutrient(s) in the formulations are generally between 0.05 and 99% by weight, 0.01 and 98% by weight, preferably between 0.1 and 95% by weight, between 0.5 and 90%, between 10 and 70%, between 20 and 60%, or between 25 and 50% by weight of plant nutrient(s). Depending on the formulation and desired route of application, one of ordinary skill in the art can determine appropriate amounts of active ingredients and additives, and the amount of active ingredient(s) and additive(s) in the formulations may vary in a broad range. The concentration of the active ingredients in the application forms is generally between 0.000001 to 95% by weight, 0.0001 and 20%, between 0.0001 and 10%, between 0.0001 and 2%, between 0.001 and 2%, between 0.01 and 1.5%, or between 0.1 and 1% by weight of active ingredients. Alternatively, a formulation can contain active ingredients at a concentration from 1 mole/liter to about 10,000 moles/liter, or from about 2 moles/liter to about 5,000 moles/liter, or from about 3 moles/liter to about 3,000 moles/liter, or from about 4 moles/liter to about 2,000 moles/liter, or from about 5 moles/liter to about 500 moles/liter, or from about 5 moles/liter to about 200 moles/liter, or from about 5 moles/liter to about 100 moles/liter, or from about 5 moles/liter to about 50 moles/liter, or from about 5 moles/liter to about 15 moles/liter, or from about 5 moles/liter to about 10 moles/liter.

The formulations mentioned can be prepared in a manner known, for example by mixing the active ingredients with at least one customary extender, solvent or diluent, adjuvant, emulsifier, dispersant, and/or binder or fixative, wetting agent, water repellent, if appropriate desiccants and UV stabilizers and, if appropriate, dyes and pigments, antifoams, preservatives, inorganic and organic thickeners, adhesives, gibberellins and also further processing auxiliaries and also water. Depending on the formulation type to be prepared further processing steps are necessary, e.g., wet grinding, dry grinding and granulation.

The formulations can include other known active ingredients. The formulation can also contain various plant growth regulators, enzyme inhibitors, and related compounds known to the art of agriculture. Also contemplated is a formulation together with, or use in conjunction with, one or more of glutamine synthetase inhibitors. The presence of one or more glutamine synthetase inhibitors in combination with the formulations is desirable. The glutamine synthetase inhibitors can be in proximity with the plant(s) being treated by the formulations. Examples of glutamine synthetase inhibitors are described in Unkefer et al.; which is herein incorporated by reference in its entirety. Other active ingredients include insecticides, attractants, sterilants, bactericides, acaricides, nematicides, growth regulators, herbicides, fertilizers, and the like.

The application of the desired amount of the formulation can be achieved with a single application, or with a plurality of applications; these applications may be substantially similar, or varied in terms of method, amount, or both.

### IV. Methods

The methods described herein involve treatment of the seeds, plant parts, and plants with the compositions or formulations directly or by action on their surroundings, by any customary treatment methods. Customary treatment methods include, but are not limited to, for example, dipping, spraying, atomizing, irrigating, evaporating, dusting, fogging, broadcasting, foaming, painting, spreading-on, watering (drenching), and/or drip irrigating. In the case of propagation material, especially in the case of seeds, treatment methods also include dry seed treatment, wet seed treatment, slurry treatment, incrustation, coating with one or more coats, etc. It is also possible to deploy the compositions or formulations by the ultra-low volume method or to inject the compositions or formulations directly into the soil. In particular, the methods can be used on soil by placing, dropping, spreading, spraying, broadcasting, deep or sub-surface placement, localized placement, contact, band, hill, and row placement, knife-in, etc., and any other method. The soil to which the currently disclosed compositions and/or formulations are applied to may be in the area near or adjacent, i.e., vicinity, to a plant of interest, such as a crop plant, and/or at the base of the plant of interest and/or in the root zone of the plant of interest. Thus, in some embodiments, the currently disclosed compositions and/or formulations are applied to the soil after the plant has emerged. For example, in some embodiments, the currently disclosed compositions and/or formulations are applied to the soil after at least about 1%, 10%, 20%, 30%, 40%, 50%, 60%, 70%, 80%, 90%, or about at least 95% emergence of the plant. In some embodiments, the currently disclosed compositions and/or formulations are applied to the soil prior to the emergence of the plant. In some embodiments, the currently disclosed compositions and/or formulations are applied for 1-3 days, 5-7 days, or 6-10 days (or 1, 2, 3, 4, 5, 6, 7, 8, 9, 10 days) after planting. Here, the composition and/or formulation is applied to an area near or adjacent to the seed that is within the soil. In some embodiments, the composition is a manufacturing article. Exemplary manufacturing articles include, but are not limited to a rod, spike, block and/or orb as described in more detail below.

The amount of the currently disclosed compositions and/or formulations can vary. A skilled artisan would know that an “effective amount” of the composition can vary based on the conditions of the soil, temperature, and/or water content. A skilled artisan would also be aware that such parameters affect the frequency of application and would optimize the effective amount of the composition as well as the frequency of the application of the composition and/or formulation accordingly.

In some embodiments, the subject matter described herein is directed to a method for improving plant properties comprising contacting the plant or area adjacent to the plant with an effective amount of a composition comprising a plant nutrient, a corresponding ester thereof, and optionally an agriculturally acceptable carrier. In some embodiments, the plant properties to be improved include, but are not limited to, increasing growth rate, increasing nodulation, increasing the percent dry weight of the plant, and/or increasing fresh weight. Such an increase is measured in comparison to untreated plants and can comprise at least an increase of about 1%, 5%, 10%, 15%, 20%, 25%, 30%, 35%, 40%, 45%, 50%, 55%, 60%, 65%, 70%, 75%, 80%, 85%, 90%, or at least 95% compared to untreated plants. In some embodiments, the plant nutrient is selected from the group consisting of pyroglutamic acid, levulinic acid, and ketosuccinimate, or a salt thereof, and a corresponding ester of Formula I, II, IIa, and/or IV.

In some embodiments, methods for improving plant growth can also be achieved by applying a currently disclosed composition as a seed coating to a seed in the form of a liquid dispersion which upon drying forms a dry residue. In these embodiments, seed coating provides the currently disclosed composition in close proximity to the seed when planted so that the agriculturally active compound can exert its beneficial effects in the environment where it is most needed. That is, the agriculturally active compound provides an environment conducive to enhanced plant growth in the area where the effects can be localized around the desired plant. In the case of seeds, the coating containing the agriculturally active compound provides an enhanced opportunity for seed germination, subsequent plant growth, and an increase in plant nutrient availability. In some embodiments, the agriculturally active compound can be present in the seed product at a level of from about 0.001-10%, about 0.004%-2%, about 0.01% to about 1%, or from about 0.1% to about 1% by weight (or no more than about 10%, about 9%, about 8%, about 7% about 6%, about 5%, about 4%, about 3%, about 2%, about 1%, about 0.5%, about 0.1%, about 0.01% or no more than 0.001%), based upon the total weight of the coated seed product.

In some embodiments, the subject matter described herein is directed to a method of increased plant vigor comprising contacting the plant or area adjacent to the plant with an effective amount of a currently disclosed composition or formulation. Increased plant vigor includes, but is not limited to, plant quality and seed vigor, reduced stand failure, improved appearance, increased recovery, improved greening effect and improved photosynthetic efficiency. Beneficial effects can also include earlier germination, better emergence, more developed root system and/or improved root growth, increased ability of tillering, more productive tillers, earlier flowering, increased plant height and/or biomass, shorting of stems, improvements in shoot growth, number of kernels/ear, number of ears/m², number of stolons and/or number of flowers, enhanced harvest index, bigger leaves, less dead basal leaves, improved phyllotaxy, earlier maturation/earlier fruit finish, homogenous ripening, increased duration of grain filling, better fruit finish, bigger fruit/vegetable size, sprouting resistance and reduced lodging. Such an increase is measured in comparison to untreated plants and can comprise at least an increase of about 1%, 5%, 10%, 15%, 20%, 25%, 30%, 35%, 40%, 45%, 50%, 55%, 60%, 65%, 70%, 75%, 80%, 85%, 90%, or at least 95% compared to untreated plants.

In some embodiments, the subject matter described herein is directed to a method of increasing the concentration of prolines in the foliar tissue of a plant by contacting the plant or area adjacent to the plant with a composition comprising pyroglutamic acid and a corresponding ester, and optionally an agriculturally acceptable carrier. In some embodiments, the concentration of prolines is increased by at least about 1%, 5%, 10%, 15%, 20%, 25%, 30%, 35%, 40%, 45%, 50%, 55%, 60%, 65%, 70%, 75%, 80%, 85%, 90%, or at least 95% compared to untreated plants.

In some embodiments, the subject matter described herein is directed to a method of increasing the strengthening effect in plants comprising contacting the plant or area adjacent to the plant with an effective amount of a currently disclosed composition or formulation. For example, the composition and/or formulation can be used for mobilizing the defenses of the plant against attack by undesirable microorganisms. Plant-strengthening (resistance-inducing) substances are to be understood as meaning, in the present context, those substances which are capable of stimulating the defense system of plants in such a way that the treated plants, when subsequently inoculated with undesirable microorganisms, develop a high degree of resistance to these microorganisms.

In some embodiments, such strengthening effect in plants also includes an increase of biotic and/or abiotic stress tolerance of plants. Abiotic stress tolerance includes, but is not limited to, an increase in temperature tolerance, drought tolerance and recovery after drought stress, water use efficiency (correlating to reduced water consumption), flood tolerance, ozone stress and UV tolerance, tolerance towards chemicals like heavy metals, salts, pesticides, etc. Biotic stress tolerance includes, but is not limited to, increased fungal resistance and increased resistance against nematodes, viruses and bacteria. In context with the present disclosure, biotic stress tolerance preferably comprises increased fungal resistance.

In some embodiments, the subject matter described herein is directed to a method for improving resistance to pests comprising contacting the plant or area adjacent to the plant with an effective amount of a composition comprising a plant nutrient as disclosed herein and optionally an agriculturally acceptable carrier. In some embodiments, the resistance to pests is measured in comparison to untreated plants and can comprise at least an increase of about 1%, 5%, 10%, 15%, 20%, 25%, 30%, 35%, 40%, 45%, 50%, 55%, 60%, 65%, 70%, 75%, 80%, 85%, 90%, or at least 95% compared to untreated plants. In some embodiments, the composition comprises a plant nutrient selected from the group consisting of pyroglutamic acid, levulinic acid, and ketosuccinimate, or a salt thereof, and a corresponding ester of Formula I, II, IIa, and IV. In some embodiments, the composition is a manufacturing article. Exemplary manufacturing articles include, but are not limited to, a rod, spike, block and/or orb.

In some embodiments, the subject matter described herein is directed to a method for increasing yield comprising contacting the plant or area adjacent to the plant with an effective amount of a composition comprising a plant nutrient, a corresponding ester thereof, and optionally an agriculturally acceptable carrier. Increased yield can refer to total biomass per hectare, yield per hectare, kernel/fruit weight, seed size and/or hectoliter weight as well as to increased product quality, comprising: improved processability relating to size distribution (kernel, fruit, etc.), homogenous ripening, grain moisture, better milling, better vinification, increased juice yield, harvestability, digestibility, sedimentation value, falling number, pod stability, storage stability, improved fiber length/strength/uniformity, increase of milk and/or meet quality of silage fed animals; further comprising improved marketability relating to improved fruit/grain quality, size distribution (kernel, fruit, etc.), increased storage/shelf-life, firmness/softness, taste (aroma, texture, etc.), grade (size, shape, number of berries, etc.), number of berries/fruits per bunch, crispness, freshness, coverage with wax, frequency of physiological disorders, color, etc.; further comprising increased desired ingredients such as e.g., protein content, fatty acids, oil content, oil quality, amino acid composition, sugar content, acid content (pH), sugar/acid ratio (Brix), polyphenols, starch content, nutritional quality, gluten content/index, energy content, taste, etc.; and further comprising decreased undesired ingredients such as e.g., less mycotoxines, less aflatoxines, geosmin level, phenolic aromas, lacchase, polyphenol oxidases and peroxidases, nitrate content, etc. In some embodiments, the yield is increased by an amount of at least about 1%, 5%, 10%, 15%, 20%, 25%, 30%, 35%, 40%, 45%, 50%, 55%, 60%, 65%, 70%, 75%, 80%, 85%, 90%, or at least 95% compared to untreated plants.

In some embodiments, the subject matter described herein is directed to a method for improving one or more of the following: the development of a plant root system, and/or water use of the plant, and/or nitrogen use of the plant and/or improved photosynthetic efficiency comprising contacting the plant or area adjacent to the plant with an effective amount of a currently disclosed composition or formulation. In some embodiments, improvements are in the form of a more developed root system. The term “more developed root system” or “improved root growth” refers to longer root system, deeper root growth, faster root growth, higher root dry/fresh weight, higher root volume, larger root surface area, bigger root diameter, higher root stability, more root branching, higher number of root hairs, and/or more root tips and can be measured by analyzing the root architecture with suitable methodologies and analysis.

In some embodiments, improvements are in the form of water use. The term “crop water use efficiency” refers technically to the mass of agriculture produce per unit water consumed and economically to the value of product(s) produced per unit water volume consumed and can, e.g., be measured in terms of yield per hectare (ha), biomass of the plants, thousand-kernel mass, and the number of ears per m².

In some embodiments, improvements are in the form of nitrogen use. The term “nitrogen-use efficiency” refers technically to the mass of agriculture produce per unit nitrogen consumed and economically to the value of product(s) produced per unit nitrogen consumed, reflecting uptake and utilization efficiency.

In some embodiments, improvements are in greening/improved color and improved photosynthetic efficiency as well as the delay of senescence can be measured with well-known techniques such as a Handy PEA system (Hansatech), net photosynthetic rate (Pn), measurement of the chlorophyll content, e.g., by the pigment extraction method of Ziegler and Ehle, measurement of the photochemical efficiency (Fv/Fm ratio), determination of shoot growth and final root and/or canopy biomass, determination of tiller density as well as of root mortality.

In some embodiments, the compositions, formulations and methods provide sustainable agriculture, comprising nutrient use efficiency, especially nitrogen (N)-use efficiency, phosphorus (P)-use efficiency, water use efficiency, improved transpiration, respiration and/or CO₂ assimilation rate, better nodulation, improved Ca-metabolism etc.

In embodiments, the plant is a crop as described elsewhere herein. In some embodiments, the crop is selected from the group consisting of cereals (wheat, rice), maize, soya beans, potatoes, cotton, oilseed rape and fruit plants. In some embodiments, the crop is maize.

The subject matter described herein is further directed to a method for treating seed. The method comprises contacting a composition or formulation comprising pyroglutamate and a fungicide with a seed, wherein a coated seed is prepared. The subject matter is further directed to the seed which has been treated by the methods. A significant part of the damage to crop plants caused by harmful organisms can be attributed to infection of the seed during storage or after sowing, and also during and after germination of the plant. This phase is particularly critical since the roots and shoots of the growing plant are particularly sensitive, and even minor damage may result in the death of the plant.

For treatment of seed with the seed dressing formulations, or the preparations prepared therefrom by adding water, all mixing units usable customarily for the seed dressing are useful. Specifically, the procedure in the seed dressing is to place the seed into a mixer, to add the particular desired amount of seed dressing formulations, either as such or after prior dilution with water, and to mix everything until the formulation is distributed homogeneously on the seed. If appropriate, this is followed by a drying process.

When using the compositions and formulations, the application rates can be varied within a relatively wide range, depending on the kind of application. The application rate of the mixtures or compositions is in the case of treatment of plant parts, for example leaves: from 0.1 to 10,000 g/ha, preferably from 10 to 1,000 g/ha, more preferably from 10 to 800 g/ha, even more preferably from 50 to 300 g/ha (in the case of application by watering or dripping, it is even possible to reduce the application rate, especially when inert substrates such as rockwool or perlite are used); in the case of seed treatment: from 2 to 200 g per 100 kg of seed, preferably from 3 to 150 g per 100 kg of seed, more preferably from 2.5 to 25 g per 100 kg of seed, even more preferably from 2.5 to 12.5 g per 100 kg of seed; in the case of soil treatment: from 0.1 to 10 000 g/ha, preferably from 1 to 5000 g/ha.

In some embodiments, the application rate of the mixtures or compositions is in the case of treatment of plants, wherein one or more applications can be delivered using drench treatments. Each application can be applied at high field rates (i.e., about 100 g to about 400 g active ingredient/acre) or low field rate (i.e., about 1 g to about 50 g active ingredient/acre). In some embodiments, the field rate is from about 1 to about 400 g/acre, from about 10 to about 350 g/acre, from about 20 to about 300 g/acre, from about 30 to about 250 g/acre, from about 40 to about 200 g/acre, from about 45 to about 150 g/acre or from about 50 to about 100 g/acre. In some embodiments, the field rate is from about 1 to about 25 g/acre, from about 25 to about 50 g/acre, from about 50 to about 75 g/acre, or from about 75 to about 100 g/acre. These application rates are merely by way of example and are not limiting as one of ordinary skill in this field can adjust the application rates as desired.

In some embodiments, the application rate of the composition and/or formulation as disclosed herein ranges from about 1 ml to about 200 mL, about 10 to about 175 mL, about 25 to about 150 mL, about 75 to about 150 mL per plant depending on the active ingredients in the composition and/or formulation and amount thereof.

The methods described herein can be used at any growth stage depending on the plant and the desired effect. However, in some embodiments, certain stages are targeted for the contacting of the compositions and formulations to promote specific effects. Stages are recognized in growing degree units (GDUs) as is known by those of ordinary skill. For example, in corn, the methods can be advantageously used post-emergence, in particular, during pollination. More specifically, the methods can be used during the tassel stage (VT) through the silking stage (R1).

In some embodiments, the subject matter described herein is directed to a method of preparing the composition of claim 1, comprising: contacting a carboxyl-containing compound selected from the group consisting of glutamic acid, pyroglutamic acid, levulinic acid, and ketosuccinimate, or salts thereof, with a polyol in the presence of an acid to form a mixture comprising the carboxyl-containing compound, or salts thereof, and an ester of the carboxyl-containing compound; and contacting the mixture with an agriculturally acceptable excipient to form the composition. The methods include contacting of the carboxyl-containing compound and the polyol in the presence of an acid at elevated temperature and under a vacuum to form a mixture of the carboxyl-containing compound and an ester of the carboxyl-containing compound. In some embodiments, the heating and vacuum is discontinued when the ratio of ester of carboxyl-containing compound to carboxyl-containing compound is greater than 0.5 to 1.

Scheme 1 shows a synthetic route for obtaining a compound of Formula IV.

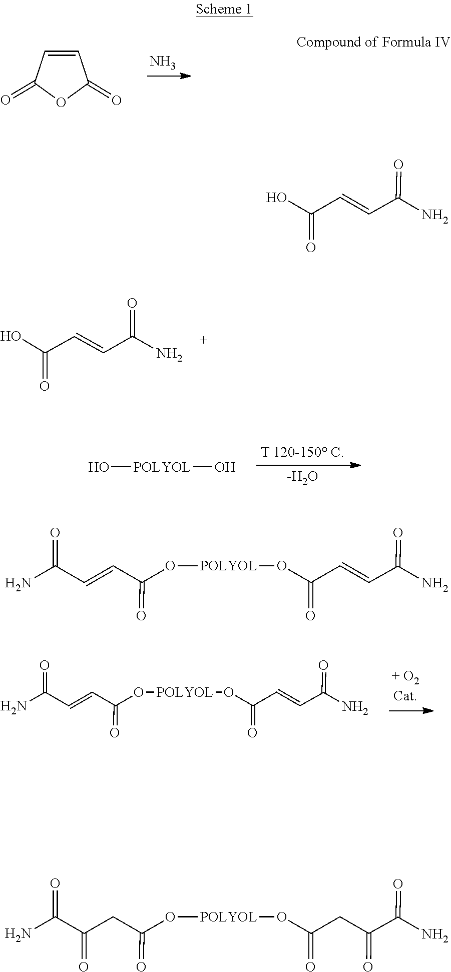

Scheme 2 shows a synthetic route for preparing a compound described herein:

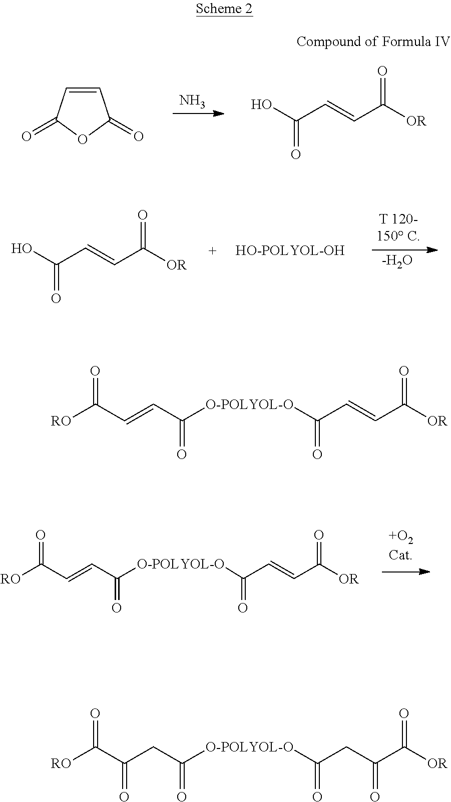

where, R is hydrogen, methyl, ethyl or propyl.

Alternatively, under conditions described above, glutamic acid can be reacted with a polyol, such as PEG, to from a PGA ester.

The method of making of the compositions can utilize various techniques available to those of skill in the field. Several useful approaches are described herein below and in the examples. In general, this is accomplished by performing an esterification reaction between the pyroglutamic acid, levulinic acid or ketosuccinimate (each in a suitable form, such as a free acid or acid anhydride) and a molecule containing at least one primary alcohol functional group prior to reaction taking place. In general, any method of making esters can be used (including such techniques as esterification and transesterification when the starting material is an alkyl ester). When the starting material is an alkyl ester, some of the alkyl ester may remain in the final composition. In the case of pyroglutamic acid, it is preferably in the form a free acid, but can also be in form of acid anhydride, acid chloride, or another form that is useful for making esters. The esterification is generally conducted at an elevated temperature, preferably in the range of about 100° C. to about 290° C., about 100° C. to about 250° C., about 125° C. to about 225° C., or about 150° C. to about 200° C.; it is preferred that the reaction be performed at a pressure below atmospheric when the reaction is such that water of condensation is among reaction products (e.g., reaction of pyroglutamic acid with tetraethylene glycol) to enhance the reaction rate, and to simultaneously and conveniently reduce the amount of oxygen in contact with the reactants and with product over the course of the reaction at elevated temperature. The esterification can be performed either directly, or using any suitable catalyst. Acid catalysts such as phosphoric, phosphorous, toluenesulfonic, or other suitable acids. In the presence of such catalysts, reaction times and temperatures are somewhat shorter and lower, respectively. At the completion of reaction the catalysts may optionally be separated by any useful means. In this way, phosphates, phosphites, and other materials may conveniently be introduced into the final formulations by not removing these materials. Such compositions may have enhanced utility in the context of productive agriculture due to the content of these materials. The acids involved may also be optionally neutralized by careful addition of suitable amounts and types of base when such an operation is desirable, such as when the formulation contains one or more acid sensitive agriculturally useful excipients.

Also within the scope of the currently disclosed subject matter is the use of in situ PGA synthesis, wherein PGA in acid form is synthesized by any suitable means known to the art, and, optionally without further isolation or purification, is reacted with the primary alcohol using any convenient method known to the art. Also contemplated is the preparation of an ester of glutamic acid by any suitable means known to the art, with a subsequent ring closing reaction to generate the PGA moiety. These two reactions may also be performed simultaneously in what can be termed a “one pot” synthesis, wherein glutamic acid and a molecule (or several different molecules) containing at least one primary alcohol group are reacted in a condensation reaction with elimination of water at elevated temperature (and optionally at reduced pressure) to produce the desired ester(s); this reaction can be conducted with an optional catalyst being present.

Other methods involve preparation of the compositions, as follows (using PGA as a non-limiting example): addition of PGA to relatively pure PGA ester(s); alternatively, not allowing the esterification reaction of PGA to proceed to substantial completion; alternatively, an excess of PGA can be supplied to the reaction such that some PGA remains unreacted, that is, esterification proceeds until the alcohol is exhausted and excess PGA is left.

The reactions may be carried out in a suitable solvent, wherein by solvent is meant any suitable material that is liquid at least at some pressure below about 10 bar and a temperature between about 100° C. and 290° C. The reaction may also be advantageously carried out as a suspension, or as any kind of a mixture, or preferably without a solvent, involving only the reactants, or with a suitable excess of the primary alcohol group containing reactant, such that it serves as both solvent and reactant. Those skilled in the art can appreciate the full breadth of the various possibilities.

Inert atmospheres, elevated and reduced pressures, temperatures, and various reactor arrangements suitable for these reactions can be routinely employed by those skilled in this field.

The method of making mixtures of the compositions with plant nutrients can be any known to the art of production of nutrients for use in productive agriculture. Among such methods are included, but not limited to, application of the compositions to granular fertilizer's granules on their exteriors, or impregnation of same throughout their volumes, addition of the compositions to fluid fertilizers to dissolve them, dispersion of same throughout a volume of liquid fertilizer, addition of the compositions to water being applied to, or next to, plants; placing of the compositions directly into soil containing plant nutrients in proximity to plants, and the like.

### V. Articles of Manufacture

In another aspect, described herein are articles of manufacture, the article comprising a composition comprising a plant nutrient selected from the group consisting of an agriculturally active compound or salt thereof, such as pyroglutamic acid, levulinic acid, and ketosuccinimate, compounds of Formula III, or a salt thereof, and a corresponding ester of Formula I, II, IIa, and IV, and optionally an agriculturally acceptable carrier, wherein the article has an engineered three-dimensional shape. The shape can be formed by any means, such as molding from a master mold. The cavity of the master mold can have any shape desired. The article prepared from such a mold will mimic the shape of the cavity of the mold. The molding will occur for a set time, which can be determined and adjusted by those of skill in this field and will depend on the chemistry of the composition. After molding for a set time, the article can have the desired shape, but can further be shaped by machining, slicing, cutting, sanding, planning, trimming and the like to prepare a three-dimensional article. In some embodiments, the article is in a shape selected from the group consisting of a rod, a spike, a prill, a stick, a block, and an orb.

Particular embodiments of the subject matter described herein include:

1. A composition comprising,

a combination comprising:
i. an agriculturally active compound having at least one carboxylic acid moiety and having the formula:

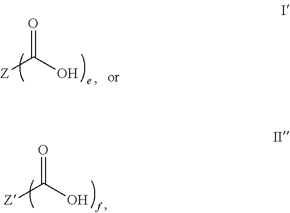

wherein, e and f are independently an integer from 1 to 4,
   Z and Z′ are a portion of the agriculturally active compound or salts thereof;

and
ii. one or more esters of said agriculturally active compound, said ester selected from the group consisting of:

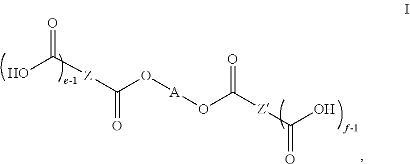

wherein, O-A-O is a residue of a first polyol;
e and f are independently an integer from 1 to 4; and
Z and Z′ are a portion of the agriculturally active compound;

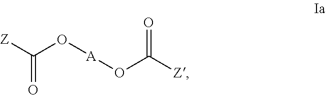

wherein, O-A-O is a residue of a first polyol; and
Z and Z′ are a portion of the agriculturally active compound

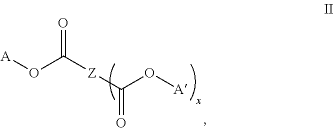

wherein,
   A-O is a residue of a first polyol;
   A′-O is a residue of a second polyol or a hydroxyl; and
   x is an integer from 0 to 3;
   Z is a portion of an agriculturally active compound
and,

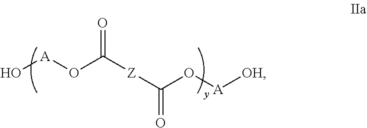

wherein,
   O-A-OH is a residue of a first polyol;
   y is an integer from 1 to 50; and
   Z is a portion of the agriculturally active compound;
      and,
iii. an agriculturally acceptable carrier.
   2. The composition of embodiment 1, wherein the agriculturally active compound having at least one carboxylic acid moiety or salts thereof is a monocarboxylic acid or dicarboxylic acid or salts thereof and the ester of said agriculturally active compound is a monoester or a diester or salts thereof.
   3. The composition of any above embodiment, wherein the ester is water soluble.
   4. The composition of any above embodiment, wherein the composition is water soluble.
   5. The composition of any above embodiment, wherein said ester has a weight averaged molecular weight of 300 D or above.
   6. The composition of any above embodiment, wherein said ester has a weight averaged molecular weight of about 300 D to about 10,000 D.
   7. The composition of any above embodiment, wherein said ester has a weight averaged molecular weight of about 350 D to about 5,000 D.
   8. The composition of any above embodiment, wherein said first polyol and said second polyol are the same type of polyol.
   9. The composition of any above embodiment, wherein said first polyol is polyethylene glycol or copolymer thereof, and said second polyol is polyethylene glycol or copolymer thereof or hydroxyl.
   10. The composition of any above embodiment, wherein said polyethylene glycol has a weight averaged molecular weight of about 150 D to about 10,000 D.
   11. The composition of any above embodiment, wherein said polyethylene glycol has a weight averaged molecular weight of about 300 D to about 8,000 D.
   12. The composition of any above embodiment, wherein said ester has a weight averaged molecular weight of about 350 D to about 8,000 D.
   13. The composition of any above embodiment, further comprising:

an ester of said agriculturally active compound, said ester having the formula:

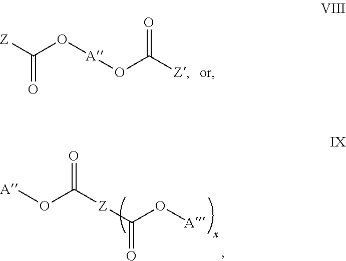

wherein, O-A″-O and A″-O are each a residue of a polyalkylene glycol other than polyethylene glycol (PEG);

A′″-O is a residue of a polyalkylene glycol other than polyethylene glycol (PEG); and

x′ is 0 or 1.

14. The composition of any above embodiment, wherein x′ is 1.
15. The composition of any above embodiment, wherein the ratio of I and/or II to VIII and/or IX is about 0.1:10 to about 10:0.1.
16. The composition of any above embodiment, wherein the ratio of I and/or II to VIII and/or IX is about 1:10 to about 10:1.
17. The composition of any above embodiment, wherein the ratio of I and/or II to VIII and/or IX is about 1:5 to about 5:1.
18. The composition of any above embodiment, wherein said first polyol and said second polyol are different types of polyol.
19. The composition of any above embodiment, wherein the ratio of said agriculturally active compound having at least one carboxylic acid moiety or salts thereof to said ester of said agriculturally active compound is about 0.01:1 to about 0.5:1.
20. The composition of any above embodiment, wherein the ratio is about 0.1:1 to about 0.3:1.
21. The composition of any above embodiment, wherein the ratio is about 0.2:1 to about 0.3:1.
22. The composition of any above embodiment, wherein said agriculturally active compound I′ or I″ is selected from the group consisting of
a. carboxylic acid containing herbicides;
b. carboxylic acid containing fungicides;
c. pyroglutamic acid;
d. levulinic acid;
e. pamoic acid;
f. ketosuccinamide; and
g. a dicarboxylic acid having the structure:

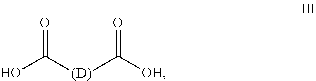

wherein, D is a linear C₁₋₅ alkyl group having at least one carbonyl embedded in the alkyl.
   23. The composition of any above embodiment, wherein said combination comprises:
i. said agriculturally active compound I′ is pyroglutamic acid having the structure

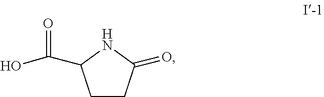

or salts thereof, and said ester of said agriculturally active compound is an ester of Formula IV:

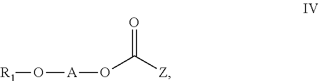

wherein,
   O-A-O is a residue of a polyol;
   Z is

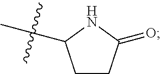 [SMILES: *C1CCC(=O)N1]

and
R₁ is absent or is selected from the group consisting of hydrogen and Q;
wherein, Q is Q¹ and has the structure:

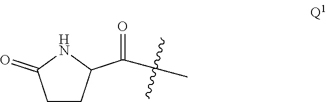

wherein,

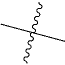

is the point of attachment;
ii. said agriculturally active compound is levulinic acid having the structure:

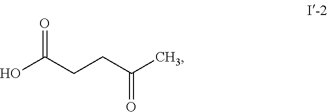

or salts thereof, and said ester of said agriculturally active compound is an ester of Formula I:

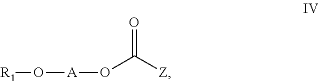

wherein,
   O-A-O is a residue of a polyol;
   Z is

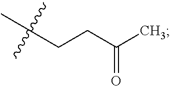 [SMILES: *CCC(C)=O]

and
R₁ is absent or is selected from the group consisting of hydrogen and Q;
wherein, Q is Q² and has the structure:

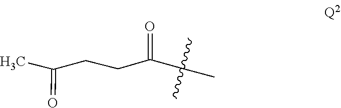

wherein,

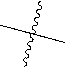

is the point of attachment;
or
iii. said agriculturally active compound is ketosuccinimate having the structure:

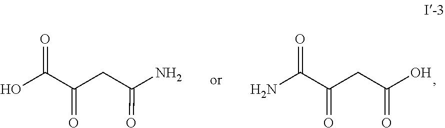 [SMILES: NC(=O)CC(=O)C(=O)O ; NC(=O)C(=O)CC(=O)O]

or salts thereof, and said ester of said agriculturally active compound is an ester of Formula I:

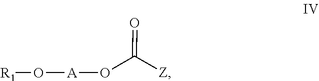

wherein,
   O-A-O is a residue of a polyol;
   Z is

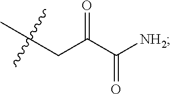 [SMILES: *CC(=O)C(N)=O]

R₁ is absent or is selected from the group consisting of hydrogen and Q;
wherein, Q is Q³ and has the structure:

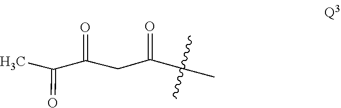

wherein,

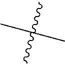

is the point of attachment;
and an agriculturally acceptable carrier.
   24. The composition of any above embodiment, comprising pyroglutamic acid or salts thereof and one or more esters of pyroglutamic acid and an agriculturally acceptable carrier, wherein the ester(s) is selected from the group consisting of Formulae V-VII:

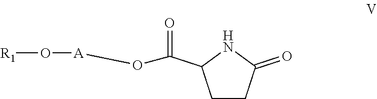

or salt thereof, wherein,
O-A-O is a residue of a linear or branched polyalkylene glycol or oligomer or dendrimer thereof, and R₁ is selected from the group consisting of hydrogen and Q¹;

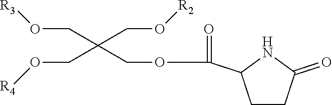

or salt thereof, wherein,
R₂, R₃ and R₄, in each instance, is independently selected from the group consisting of hydrogen and Q¹;

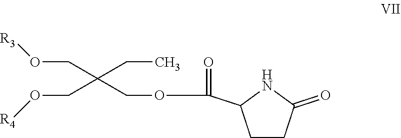

or salt thereof, wherein,
R₃ and R₄, in each instance, is independently selected from the group consisting of hydrogen and Q¹.
   25. The composition of any above embodiment, wherein the pyroglutamic acid or salt thereof is present in an amount from about 1% to about 90% by mole based on the number of total moles of the pyroglutamic acid or salt thereof and the ester of pyroglutamic acid or salt thereof.
   26. The composition of any above embodiment, wherein the pyroglutamic acid or salt thereof is present in an amount from about 2% to about 80% by mole based on the total number of moles of the pyroglutamic acid or salt thereof and the ester of pyroglutamic acid or salt thereof.
   27. The composition of any above embodiment, wherein the pyroglutamic acid or salt thereof is present in an amount from about 3% to about 50% by mole based on the total number of moles of the pyroglutamic acid or salt thereof and the ester of pyroglutamic acid or salt thereof.
   28. The composition of any above embodiment, wherein the residue of a linear or branched polyalkylene glycol or oligomer or dendrimer thereof is a residue of PEG or PPG.
   29. The composition of any above embodiment, wherein the ester is of Formula Va:

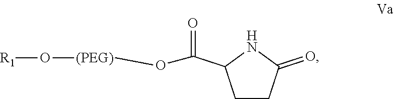

wherein, O-PEG-O is a residue of PEG.

30. The composition of any above embodiment, wherein the ester of pyroglutamic acid has a weight averaged molecular weight from about 200 Da to about 10,000 Da.
31. The composition of any above embodiment, wherein the ester of pyroglutamic acid has a weight averaged molecular weight from about 300 Da to about 5,000 Da.
32. The composition of any above embodiment, wherein the ester of pyroglutamic acid has a weight averaged molecular weight from about 350 Da to about 3,500 Da.
33. The composition of any above embodiment, wherein the ester of pyroglutamic acid has a weight averaged molecular weight from about 600 Da to about 1,700 Da.
34. The composition of any above embodiment, wherein from about 10% to about 90% of R₁ is Q and the remainder of R₁ is hydrogen.
35. The composition of any above embodiment, wherein O-A-O is a residue of pentaerythritol the ester of pyroglutamic acid is of Formula VI:

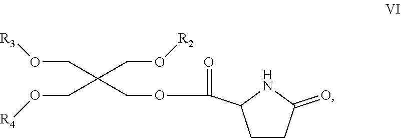

wherein from about 10% to about 90% of the total of R₂, R₃ and R₄ is Q¹ and the remainder of R₂, R₃ and R₄ is hydrogen.

36. The composition of any above embodiment, wherein O-A-O is a residue of trimethylpropane and the ester of pyroglutamic acid is of Formula VII:

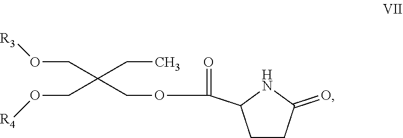

wherein from about 10% to about 90% of the total of R₅ and R₆ is Q¹ and the remainder of R₅ and R₆ is hydrogen.

37. The composition of any above embodiment, comprising a mixture of esters of pyroglutamic acid, the mixture comprising Formulae V and VI; Formulae V and VII; Formulae VI and VII; and Formula V, VI and VII.
38. The composition of any above embodiment, wherein from about 50% to about 100% of the pyroglutamic acid ester(s) is hydrolyzed over a period of about 50 days or less after the composition is contacted with the plant or area adjacent to the plant.
39. The composition of any above embodiment, wherein from about 50% to about 100% of the pyroglutamic acid ester(s) is hydrolyzed over a period of about 30 days or less after the composition is contacted with the plant or area adjacent to the plant.
40. The composition of any above embodiment, wherein from about 50% to about 100% of the pyroglutamic acid ester(s) is hydrolyzed over a period of about 10 days or less after the composition is contacted with the plant or area adjacent to the plant.
41. The composition of any above embodiment, wherein about 100% of the pyroglutamic acid ester(s) is hydrolyzed over a period of about 40 days or less after the composition is contacted with the plant or area adjacent to the plant.
42. The composition of any above embodiment, wherein pyroglutamic acid is released over a period of about 50 days or less after the composition is contacted with the plant or area adjacent to the plant.
43. The composition of any above embodiment, wherein pyroglutamic acid is released over a period of about 40 days or less after the composition is contacted with the plant or area adjacent to the plant.
44. The composition of any above embodiment, wherein said agriculturally active compound I or I′ is:

g. a dicarboxylic acid having the structure:

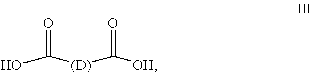

wherein, D is an optionally substituted linear C₁₋₅ alkyl group having at least one carbonyl embedded in the alkyl.
   45. The composition of any above embodiment, wherein D is

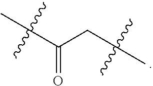 [SMILES: *CC(*)=O]

46. The composition of any above embodiment, wherein the ester of said agriculturally active compound has the Formula IIa′:

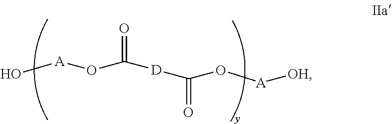

wherein, D is

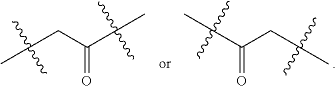 [SMILES: *CC(*)=O ; *CC(*)=O]

47. The composition of any above embodiment, wherein O-A and O-A-OH, in each instance, is a residue of a polyalkylene glycol.
48. The composition of any above embodiment, wherein O-A and O-A-OH, in each instance, can be a residue of a different polyalkylene glycol.
49. The composition of any above embodiment, wherein O-A and O-A-OH, in each instance, is a residue of tetraethylene glycol.
50. The composition of any above embodiment, wherein A, in each instance, has the structure:

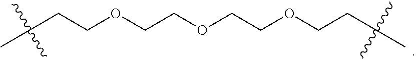 [SMILES: *CCOCCOCCOCC*]

51. The composition of any above embodiment, wherein from about 50% to about 100% of the ester of said agriculturally active compound is hydrolyzed over a period of about 50 days or less after the composition is contacted with the plant or area adjacent to the plant.
52. The composition of any above embodiment, wherein the agriculturally active compound I′ or I″, each having at least one carboxylic acid moiety or salts thereof is released over a period of about 50 days or less after the composition is contacted with the plant or area adjacent to the plant.
53. The composition of any above embodiment, wherein said agriculturally active compound I′ or I″ is a herbicide selected from the group consisting of benzoic acid herbicides, pyrimidinyloxybenzoic acid herbicides, pyrimidinylthiobenzoic acid herbicides, picolinic acid herbicides, quinolinecarboxylic acid herbicides, phenoxyacetic and arylphenoxy propionic herbicides, phenoxybutyric herbicides, and phenoxypropionic herbicides and carboxylic acid analogs thereof and salts thereof.
54. The composition of embodiment 53, wherein said herbicide is a benzoic acid selected from the group consisting of cambendichlor, chloramben, dicamba, 2,3,6-TBA, and tricamba and carboxylic acid analogs thereof and salts thereof.
55. The composition of embodiment 53, wherein said herbicide is a pyrimidinyloxybenzoic acid selected from the group consisting of byspyribac and pyriminobac and carboxylic acid analogs thereof and salts thereof.
56. The composition of embodiment 53, wherein said herbicide is a pyrimidinylthiobenzoic acid that is pyrithiobac.
57. The composition of embodiment 53, wherein said herbicide is a picolinic acid selected from the group consisting of aminopyralid, clopyralid, florpyrauxifen, halauxifen and picloram.
58. The composition of embodiment 53, wherein said herbicide is a quinolinecarboxylic acid selected from the group consisting of quinclorac and quinmerac.
59. The composition of embodiment 53, wherein said herbicide is a phenoxyacetic herbicide selected from the group consisting of clacyfos, 4-CPA, 2,4-D, 3,4-DA, MCPA, MCPA-thioethyl, and 2,4,5-T.
60. The composition of embodiment 53, wherein said herbicide is a phenoxybutyric acid selected from the group consisting of 4-CPB, 2,4-DB, 3,4-DB, MCPB, and 2,4,5-TB.
61. The composition embodiment 53, wherein said herbicide is a phenoxypropionic acid selected from the group consisting of cloprop, 4-CPP, dichlorprop, dichlorprop-P, 3,4-DP, fenoprop, mecoprop, and mecoprop-P.
62. The composition of embodiment 53, wherein said herbicide is an arylphenoxypropionic acid selected from the group consisting of chlorazifop, clodinafop, clofop, cyhalofop, diclofop, fenoxaprop, fenoxaprop-P, fenthiafop, fluazifop, fluazifop-P, haloxyfop, haloxyfop-P, isoxapyrifop, kuicaoxi, metamifop, propaquizafop, quizalofop, quizalofop-P, trifop, and endothal.
63. The composition of any one of embodiments 1-52, wherein said agriculturally active compound I′ or I″ is a fungicide selected from the group consisting of acylamino acid fungicides, antibiotic fungicides, and methoxyacrylate strobulin fungicides and carboxylic acid analogs thereof and salts thereof.
64. The composition of embodiment 63, wherein said fungicide is an acylamino acid fungicide selected from the group consisting of benalaxyl, benalaxyl-M, furalaxyl, metalaxyl, metalaxyl-M, pefurazoate, and valifenalate and carboxylic acid analogs thereof and salts thereof.
65. The composition of embodiment 63, wherein said fungicide is an antibiotic fungicide selected from the group consisting of blasticidin-S, kasugamycin, natamycin, and polyoxorim.
66. The composition of embodiment 63, wherein said fungicide is a methoxyacrylate strobilurin fungicide selected from the group consisting of azoxystrobin, bifujunzhi, coumoxystrobin, enoxastrobin, flufenoxystrobin, jiaxiangjunzhi, picoxystrobin, pyraoxystrobin, cloquintocet, fenchlorazole, isoxadifen, mefenpyr, and megatomoic acid and carboxylic acid analogs thereof and salts thereof.
67. A method for improving plant properties including increasing growth rate, increasing nodulation, increasing the percent dry weight of the plant, increasing fresh weight, and improving resistance to pests comprising contacting the plant or area adjacent to the plant with an effective amount of a composition of any one of embodiments 1-66.
68. A method of increasing the concentration of prolines in the foliar tissue of a plant by contacting the plant or area adjacent to the plant with a composition any one of embodiments 1-66.
69. An article, the article comprising a composition of any one of embodiments 1-66 and having an engineered three-dimensional shape.
70. The article of embodiment 69, wherein the shape is selected from the group consisting of a rod, a spike, a block, and an orb.
71. A method for improving plant properties including increasing growth rate, increasing nodulation, increasing the percent dry weight of the plant, increasing fresh weight, and improving resistance to pests comprising contacting the area adjacent to the plant with an article of embodiment 69 or 70.
72. A method of increasing the concentration of prolines in the foliar tissue of a plant by contacting the area adjacent to the plant with an article of embodiment 69 or 70.
73. A method of preparing the composition of embodiment 1, comprising:

contacting an agriculturally active compound I′ or I″, or a precursor thereof, each having at least one carboxylic acid moiety or salts thereof, with a polyol in the presence of an acid to form a mixture comprising the agriculturally active compound I′ or I″, or salts thereof, and an ester of the agriculturally active compound I′ or I″, and

contacting the mixture with an agriculturally acceptable excipient to form the composition.

74. The method of embodiment 73, further comprising monitoring the reaction to determine the amount of ester formed and quenching the reaction before greater than 90% of the acid is converted to ester.
75. A method of preparing the composition of embodiment 23, comprising:

contacting an agriculturally active compound I′ or I″ selected from the group consisting of glutamic acid, pyroglutamic acid, levulinic acid, and ketosuccinimate, or salts thereof, with a polyol in the presence of an acid to form a mixture comprising the agriculturally active compound I′ or I″, or salts thereof, and an ester of the agriculturally active compound I′ or I″, and

contacting the mixture with an agriculturally acceptable excipient to form the composition.

76. The method of embodiment 75, wherein the precursor is glutamic acid.
77. The method of embodiment 75, wherein contacting of the glutamic acid and the polyol in the presence of an acid is conducted by heating at elevated temperature and under a vacuum to form a mixture of pyroglutamic acid and an ester of pyroglutamic acid.
78. The method of embodiment 77, wherein said heating and vacuum is discontinued when the ratio of pyroglutamic acid to pyroglutamic acid ester is greater than 0.5 to 1.
79. A method of increasing the concentration of prolines in the foliar tissue of a plant by contacting the area of the plant with a composition comprising pyroglutamic acid and one or more esters of pyroglutamic acid or salt thereof, wherein the ester(s) is selected from the group consisting of Formulae V-VII:

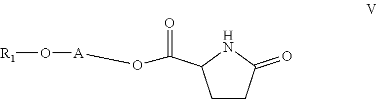

wherein,
   O-A-O is a residue of a polyalkylene glycol radical, and
   R₁ is selected from the group consisting of hydrogen and Q¹;

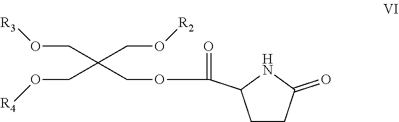

wherein,
   R₂, R₃ and R₄, in each instance, is independently selected from the group consisting of hydrogen and Q¹;

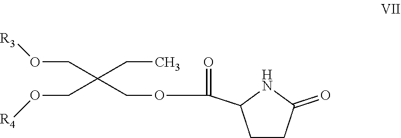

wherein,
   R₅ and R₆, in each instance, is independently selected from the group consisting of hydrogen and Q¹;
wherein, Q¹ has the structure:

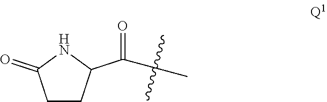

wherein,

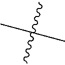

is the point of attachment.
   83. A method for improving plant properties including increasing growth rate, increasing nodulation, increasing the percent dry weight of the plant, increasing fresh weight, and improving resistance to pests comprising contacting the plant with an effective amount of a composition comprising pyroglutamic acid and one or more esters of pyroglutamic acid or salt thereof, wherein the ester(s) is selected from the group consisting of Formulae V-VII:

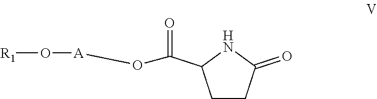

wherein,
   O-A-O is a residue of a polyalkylene glycol radical, and
   R₁ is selected from the group consisting of hydrogen and Q¹;

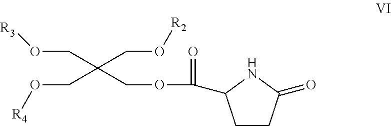

wherein,
   R₂, R₃ and R₄, in each instance, is independently selected from the group consisting of hydrogen and Q¹;

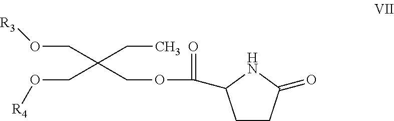

wherein,
   R₅ and R₆, in each instance, is independently selected from the group consisting of hydrogen and Q¹;
wherein, Q¹ has the structure:

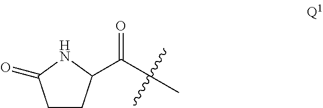

wherein,

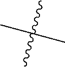

is the point of attachment.
   84. An article, the article having an engineered three-dimensional shape and comprising pyroglutamic acid and one or more esters of pyroglutamic acid or salt thereof, wherein the ester(s) is selected from the group consisting of Formulae V-VII:

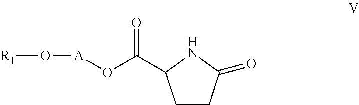

wherein,
   O-A-O is a residue of a polyalkylene glycol radical, and
   R₁ is selected from the group consisting of hydrogen and Q¹;

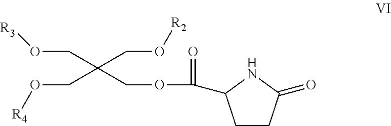

wherein,
   R₂, R₃ and R₄, in each instance, is independently selected from the group consisting of hydrogen and Q¹;

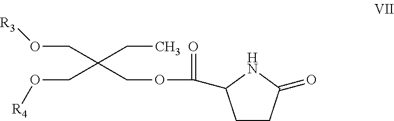

wherein,
   R₅ and R₆, in each instance, is independently selected from the group consisting of hydrogen and Q¹;
wherein, Q¹ has the structure:

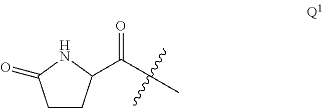

wherein,

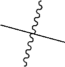

is the point of attachment.
   84. The method of any one of embodiments 67, 68, 71, 72, 79, and 83, wherein said plant is selected from the group consisting of cereals (wheat, rice), maize, soya beans, potatoes, cotton, oilseed rape and fruit plants.
   85. The method of embodiment 84, wherein the plant is maize.
   86. The composition of embodiment 23, wherein the pyroglutamic acid is L-pyroglutamic acid.
   87. The method of embodiment 79, wherein the pyroglutamic acid is a mixture of L- and D-pyroglutamic acid in a ratio of L to D of from about 80:20 to about 97:3.
   88. The method of any one of embodiments 67, 68, 71, 72, 79, 83, and 87, wherein the composition is applied to the soil adjacent to a plant, at the base of the plant, or in the root zone of the plant.
   89. The method of any one of embodiments 67, 68, 71, 72, 79, 83, 87, and 88, wherein the composition is applied to the soil after emergence of a planted crop.
   90. The method of any one of embodiments 67, 68, 71, 72, 79, 83, 87, 88, and 89, wherein the composition can be applied to the soil by dipping, spraying, atomizing, irrigating, evaporating, dusting, fogging, broadcasting, foaming, painting, spreading-on, watering, drenching, and/or drip irrigating.
   91. The method of any one of embodiments 67, 68, 71, 72, 79, 83, 87, 88, 89, and 90, wherein the composition is applied to the soil in amount ranging from about 50 g/acre to about 100 g/acre.
   92. A method for improving resistance to pests comprising contacting the area adjacent to the plant with a composition of any one of embodiments 1-66.

The following examples are offered by way of illustration and not by way of limitation.

### EXAMPLES

Analytical note: PGA measurements in this section are done on a free acid basis using HPLC techniques, with PGA peak in each analysis checked for purity using UV-Vis spectroscopy technique by comparison with a known standard reference material.

### Example 1: PGA Stability

Experiments were conducted to determine the relative stability of PGA to degradation in 250 mM sodium phosphate aqueous buffers at pH levels of interest representing pH levels commonly found in soils. PGA is sufficiently stable at the pH levels of interest. PGA/pH 5.75 L-Pyroglutamic acid was dissolved to a concentration of about 1.0% in 250 mM sodium phosphate aqueous buffer at pH of 5.75, and stored for 24 hours at 50 degrees C. No detectable decomposition was found by HPLC analysis during this period. PGA/pH 6.75 L-Pyroglutamic acid was dissolved to a concentration of about 1.0% in 250 mM sodium phosphate aqueous buffer at pH of 6.75, and stored for 24 hours at 50 degrees C. No detectable decomposition was found by HPLC analysis during this period. PGA/pH 7.75 L-Pyroglutamic acid was dissolved to a concentration of about 1.0% in 250 mM sodium phosphate aqueous buffer at pH of 7.75, and stored for 24 hours at 50 degrees C. No detectable decomposition was found by HPLC analysis during this period.

### Example 2: PGA Ester Synthesis

Experiments were conducted to test a method of direct acid catalyzed condensation between hydroxyl terminated linear PEGs and free acid form of PGA. The experiments were deliberately intended not to provide complete reaction of free PGA content, which is a desirable component of the compositions. To achieve this, the reactions were monitored as they occurred using HPLC and were stopped before free PGA was completely consumed. The mole ratio in these reactions of PGA to PEG is about 2:1. Product formation was confirmed by FT-IR spectroscopy.

2a. Synthesis of Approx. 600 Da MW PGA Diester of PEG:
React 100 g of PEG (MW about 400 Da) with 64.56 g PGA (about 2:1 mole ratio of PGA to PEG) in the presence of 1.5 g phosphoric acid (on actives basis) over 6 hours at 150 C with vigorous stirring under vacuum of about 11-17 torr absolute pressure. About 90% of PGA is esterified based in HPLC analysis for free PGA in product. Product is a light yellow somewhat viscous liquid.
2b. Synthesis of Approx. 800 Da MW PGA Diester of PEG.
React 100 g of PEG (MW about 600 Da) with 45.07 g PGA (about 2:1 mole ratio of PGA to PEG) in the presence of 1.5 g phosphoric acid (on actives basis) over 4 hours at 150 C with vigorous stirring under vacuum of about 18-25 torr absolute pressure. About 85% of PGA is esterified based in HPLC analysis for free PGA in product. Product is a light yellow viscous liquid.
2c. Synthesis of Approx. 1700 Da MW PGA Diester of PEG.
React 130 g of PEG (MW about 1500 Da) with 23.02 g PGA (about 2:1 mole ratio of PGA to PEG) in the presence of 1.5 g phosphoric acid (on actives basis) over 3 hours at 150 C with vigorous stirring under vacuum of about 2.0-6.0 torr absolute pressure. About 80% of PGA is esterified based in HPLC analysis for free PGA in product. Product is a white solid with a melting point of about 35-40 degrees C.

### Example 3: Stability of Approx. 600 Da MW PGA Ester

Stability tests were conducted to determine the rate of hydrolysis of PGA esters prepared in Example 2a. Tests were conducted in highly aqueous media under controlled conditions representing a variety of soil pH levels that may be encountered. Due to the lack of diffusion limitations imposed by soil, as well as the elevated temperature and very high water content of these tests, the absolute rates of hydrolysis shown in such tests are indicative of soil, but may be a higher rate than in actual soil.

3a. Product obtained in Example 2a is placed into the same buffer (pH 5.75) as Example 1a at a concentration of about 1.5% (plus or minus 0.5%) at a temperature of about 25-30 C, and periodically sampled for free PGA content. PGA content expressed as % of theoretical maximum PGA concentration possible if all PGA ester was fully hydrolyzed.

TABLE 1
Percent Release of Approx. 600 Da
MW PGA diester of PEG at pH 5.75.

| Hours | % Release |
|---|---|
| 3 | 14 |
| 24 | 23 |
| 48 | 29 |
| 120 | 44 |
| 170 | 51 |

3b. Product obtained in Example 2a is placed into the same buffer (pH 6.75) as Example 1b at a concentration of about 1.5% (plus or minus 0.5%) at a temperature of about 25-30 C, and periodically sampled for free PGA content. PGA content expressed as % of theoretical maximum PGA concentration possible if all PGA ester was fully hydrolyzed.

TABLE 2
Percent Release of Approx. 600 Da
MW PGA diester of PEG at pH 6.75.

| Hours | % Release |
|---|---|
| 3 | 16 |
| 24 | 48 |
| 48 | 66 |
| 120 | 89 |
| 170 | 93 |

Example 3c. Product obtained in Example 2a is placed into the same buffer (pH 7.75) as Example 1c at a concentration of about 1.5% (plus or minus 0.5%) at a temperature of about 25-30 C, and periodically sampled for free PGA content. PGA content expressed as % of theoretical maximum PGA concentration possible if all PGA ester was fully hydrolyzed.

TABLE 3
Percent Release of Approx. 600 Da
MW PGA diester of PEG at pH 7.75.

| Hours | % Release |
|---|---|
| 3 | 21 |
| 24 | 72 |
| 48 | 89 |
| 120 | 100 |
| 170 | 100 |

### Example 4: Stability of Approx. 800 Da MW PGA Ester

Stability tests were conducted to determine the rate of hydrolysis of PGA esters prepared in Example 2b. Tests were conducted in highly aqueous media under controlled conditions representing a variety of soil pH levels that may be encountered. Due to the lack of diffusion limitations imposed by soil, as well as the elevated temperature and very high water content of these tests, the absolute rates of hydrolysis shown in such tests are indicative of soil, but may be a higher rate than in actual soil.

4a. Product obtained in Example 2b is placed into the same buffer (pH 5.75) as Example 1a at a concentration of about 1.5% (plus or minus 0.5%) at a temperature of about 25-30 C, and periodically sampled for free PGA content. PGA content expressed as % of theoretical maximum PGA concentration possible if all PGA ester was fully hydrolyzed.

TABLE 4
Percent Release of Approx. 800 Da
MW PGA diester of PEG at pH 5.75.

| Hours | % Release |
|---|---|
| 3 | 20 |
| 24 | 27 |
| 48 | 33 |
| 120 | 44 |
| 170 | 52 |

4b. Product obtained in Example 2b is placed into the same buffer (pH 6.75) as Example 1b at a concentration of about 1.5% (plus or minus 0.5%) at a temperature of about 25-30 C, and periodically sampled for free PGA content. PGA content expressed as % of theoretical maximum PGA concentration possible if all PGA ester was fully hydrolyzed.

TABLE 5
Percent Release of Approx. 800 Da
MW PGA diester of PEG at pH 6.75.

| Hours | % Release |
|---|---|
| 3 | 22 |
| 24 | 51 |
| 48 | 68 |
| 120 | 90 |
| 170 | 94 |

4c. Product obtained in Example 2b is placed into the same buffer (pH 7.75) as Example 1c at a concentration of about 1.5% (plus or minus 0.5%) at a temperature of about 25-30 C, and periodically sampled for free PGA content. PGA content expressed as % of theoretical maximum PGA concentration possible if all PGA ester was fully hydrolyzed.

TABLE 6
Percent Release of Approx. 800 Da
MW PGA diester of PEG at pH 7.75.

| Hours | % Release |
|---|---|
| 3 | 27 |
| 24 | 75 |
| 48 | 90 |
| 120 | 100 |
| 170 | 100 |

### Example 5: Stability of Approx. 1700 Da MW PGA Ester

Stability tests were conducted to determine the rate of hydrolysis of PGA esters prepared in Example 2c. Tests were conducted in highly aqueous media under controlled conditions representing a variety of soil pH levels that may be encountered. Due to the lack of diffusion limitations imposed by soil, as well as the elevated temperature and very high water content of these tests, the absolute rates of hydrolysis shown in such tests are indicative of soil, but may be a higher rate than in actual soil.

5a. Product obtained in Example 2c is placed into the same buffer (pH 5.75) as Example 1a at a concentration of about 1.5% (plus or minus 0.5%) at a temperature of about 25-30 C, and periodically sampled for free PGA content. PGA content expressed as % of theoretical maximum PGA concentration possible if all PGA ester was fully hydrolyzed.

TABLE 7
Percent Release of Approx. 1700 Da
MW PGA diester of PEG at pH 5.75.

| Hours | % Release |
|---|---|
| 3 | 25 |
| 24 | 32 |
| 48 | 37 |
| 120 | 47 |
| 170 | 52 |

5b. Product obtained in Example 2c is placed into the same buffer (pH 6.75) as Example 1b at a concentration of about 1.5% (plus or minus 0.5%) at a temperature of about 25-30 C, and periodically sampled for free PGA content. PGA content expressed as % of theoretical maximum PGA concentration possible if all PGA ester was fully hydrolyzed.

TABLE 8
Percent Release of Approx. 1700 Da
MW PGA diester of PEG at pH 6.75.

| Hours | % Release |
|---|---|
| 3 | 26 |
| 24 | 55 |
| 48 | 72 |
| 120 | 92 |
| 170 | 94 |

5c. Product obtained in Example 2c is placed into the same buffer (pH 7.75) as Example 1c at a concentration of about 1.5% (plus or minus 0.5%) at a temperature of about 25-30 C, and periodically sampled for free PGA content. PGA content expressed as % of theoretical maximum PGA concentration possible if all PGA ester was fully hydrolyzed.

TABLE 9
Percent Release of Approx. 1700 Da
MW PGA diester of PEG at pH 7.75.

| Hours | % Release |
|---|---|
| 3 | 31 |
| 24 | 79 |
| 48 | 93 |
| 120 | 100 |
| 170 | 100 |

### Example 6: Temperature Stability

Tests were conducted to determine the temperature dependence of PGA esters' hydrolysis rate for esters prepared in Example 2 when present in highly aqueous media under controlled conditions representing a variety of soil pH levels that may be encountered. Higher temperatures result in relatively faster hydrolysis rates. Due to the lack of diffusion limitations imposed by soil, as well as the elevated temperature and very high water content of these tests, the absolute rates of hydrolysis shown in such tests are indicative of soil, but may be a higher rate than in actual soil.

6a. Product obtained in Example 2a is placed into the same buffer (pH 5.75) as Example 1a at a concentration of about 1.0% (plus or minus 0.5%) at a temperature of about 50 C, and sampled for free PGA content after 72 hours. PGA content expressed as % of theoretical maximum PGA concentration possible if all PGA ester was fully hydrolyzed. 100% of PGA was released.
6b. Product obtained in Example 2b is placed into the same buffer (pH 5.75) as Example 1a at a concentration of about 1.0% (plus or minus 0.5%) at a temperature of about 50 C, and sampled for free PGA content after 72 hours. PGA content expressed as % of theoretical maximum PGA concentration possible if all PGA ester was fully hydrolyzed. 100% of PGA was released.
6c. Product obtained in Example 2c is placed into the same buffer (pH 5.75) as Example 1a at a concentration of about 1.0% (plus or minus 0.5%) at a temperature of about 50 C, and sampled for free PGA content after 72 hours. PGA content expressed as % of theoretical maximum PGA concentration possible if all PGA ester was fully hydrolyzed. 100% of PGA was released.
6d. Product obtained in Example 2a is placed into the same buffer (pH 6.75) as Example 1b at a concentration of about 1.0% (plus or minus 0.5%) at a temperature of about 50 C, and sampled for free PGA content after 72 hours. PGA content expressed as % of theoretical maximum PGA concentration possible if all PGA ester was fully hydrolyzed. 100% of PGA was released.
6e. Product obtained in Example 2b is placed into the same buffer (pH 6.75) as Example 1b at a concentration of about 1.0% (plus or minus 0.5%) at a temperature of about 50 C, and sampled for free PGA content after 72 hours. PGA content expressed as % of theoretical maximum PGA concentration possible if all PGA ester was fully hydrolyzed. 100% of PGA was released.
6f. Product obtained in Example 2c is placed into the same buffer (pH 6.75) as Example 1b at a concentration of about 1.0% (plus or minus 0.5%) at a temperature of about 50 C, and sampled for free PGA content after 72 hours. PGA content expressed as % of theoretical maximum PGA concentration possible if all PGA ester was fully hydrolyzed. 100% of PGA was released.
6g. Product obtained in Example 2a is placed into the same buffer (pH 7.75) as Example 1c at a concentration of about 1.0% (plus or minus 0.5%) at a temperature of about 50 C, and sampled for free PGA content after 72 hours. PGA content expressed as % of theoretical maximum PGA concentration possible if all PGA ester was fully hydrolyzed. 100% of PGA was released.
6h. Product obtained in Example 2b is placed into the same buffer (pH 7.75) as Example 1c at a concentration of about 1.0% (plus or minus 0.5%) at a temperature of about 50 C, and sampled for free PGA content after 72 hours. PGA content expressed as % of theoretical maximum PGA concentration possible if all PGA ester was fully hydrolyzed. 100% of PGA was released.
6i. Product obtained in Example 2c is placed into the same buffer (pH 7.75) as Example 1c at a concentration of about 1.0% (plus or minus 0.5%) at a temperature of about 50 C, and sampled for free PGA content after 72 hours. PGA content expressed as % of theoretical maximum PGA concentration possible if all PGA ester was fully hydrolyzed. 100% of PGA was released.

### Example 7: Corn Plant Study with PGA Ester Compounds 1-4

Corn seeds were sown in Classic 600 size pots and grown for a period of 30 days. Plants were grown in peat-based media (Fafard #2/Sunshine Mix #8 soilless media: 75% Canadian sphagnum peat moss, 20% perlite, 5% vermiculite, trace: dolomitic limestone, wetting agent, silicon). Beginning on 0-1 days after planting, all plants were drench fertilized 3×/week during the experiment (100-150 mL/plant). Beyond the water supplied via fertigation, plants were hand-watered, as needed. The Growth chamber conditions were set as follows: Temperature: 28° C. day/23° C.; Relative humidity: 40-60%; Photoperiod: 16 hours light/8 hours dark; and Light intensity: 800 μMols/m2/s.

Each compound was delivered at high and low field rates (100 g active ingredient/acre, 50 g active ingredient/acre, respectively). All drench treatments were delivered by a single application (150 mL/plant) 5-7 days after planting, or at least ˜80% emergence. Control plants received an equivalent volume of water by drench. Treatments were laid out in a completely randomized design across the experiment. Five biological replications were grown for each treatment combination.

Non-destructive data was collected on days 7, 14, 21, and 30, as outlined below. On day 30, all plants were assigned a phytoxicity rating, based on a 0-9 phenotyping scale. Control plants were treated as the standard by which other plants are rated. On day 30, destructive data was collected, as outlined below.

### Non-Destructive Sampling

On days 7, 14, 21, 30 the following data will be taken:

Photographs of representative plants in each treatment group.

Stem diameter measured 5 cm above the soil.

Plant growth stage, based on the majority stage for each treatment.

Chlorophyll concentration on each plant using an MC-100 Chlorophyll Concentration Meter (Apogee, Logan, Utah). Three measurements were taken on the most basal true leaf of each plant. The average across these three readings acts as the measurement for a given plant.

Soil solution pH, and temperature

### Destructive Sampling

Plants were destructively sampled 21 days after planting, and the following data collected:

Leaf area

Dry shoot biomass

Specific leaf area (derived from leaf area and shoot biomass)

Leaf nutrient analysis

All technical and scientific terms used herein have the same meaning. Efforts have been made to ensure accuracy with respect to numbers used (e.g., amounts, temperature, etc.) but some experimental errors and deviations should be accounted for.

Throughout this specification and the claims, the words “comprise,” “comprises,” and “comprising” are used in a non-exclusive sense, except where the context requires otherwise. It is understood that embodiments described herein include “consisting of” and/or “consisting essentially of” embodiments.

As used herein, the term “about,” when referring to a value is meant to encompass variations of, in some embodiments ±20%, in some embodiments ±15%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller rangers is also encompassed, subject to any specifically excluded limit in the stated range. Where the stated range includes one or both of the limits, ranges excluding either or both of those included limits are also included.

Many modifications and other embodiments set forth herein will come to mind to one skilled in the art to which this subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A composition comprising:
i. an agriculturally active compound having at least one carboxylic acid moiety and having a formula: 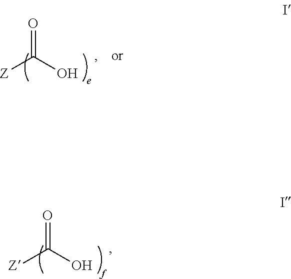
or salts thereof,
wherein
e and f are independently an integer from 1 to 4, and
Z and Z′ are a portion of the agriculturally active compound;
ii. one or more ester(s) of the agriculturally active compound selected from the group consisting of: 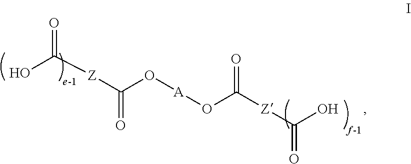
wherein,
O-A-O is a residue of a first polyol;
e and f are independently an integer from 1 to 4; and
Z and Z′ are a portion of the agriculturally active compound; 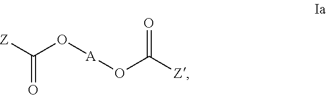
wherein,
O-A-O is the residue of a first polyol; and
Z and Z′ are a portion of the agriculturally active compound; 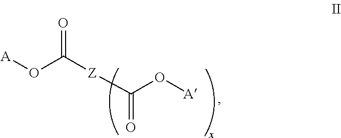
wherein,
A-O is a residue of a first polyol;
A′-O is a residue of a second polyol or a hydroxyl group;
x is an integer from 0 to 3; and
Z is a portion of an agriculturally active compound; 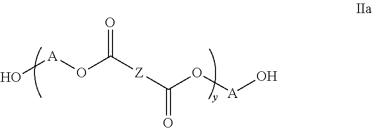
wherein,
O-A-OH is a residue of a first polyol;
y is an integer from 1 to 50; and
Z is a portion of the agriculturally active compound; and 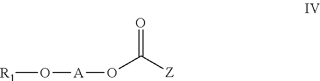
wherein,
O-A-O is a residue of a polyol;
Z is a portion of the agriculturally active compound; and
R₁ is absent or is selected from hydrogen and Q, wherein Q is Z′; and
iii. an agriculturally acceptable carrier.

2. The composition of claim 1, wherein the agriculturally active compound is a monocarboxylic acid or dicarboxylic acid and the ester of said agriculturally active compound is a monoester or a diester.

3. (canceled)

4. (canceled)

5. (canceled)

6. The composition of claim 1, wherein said first polyol is polyethylene glycol or a copolymer thereof, and said second polyol is polyethylene glycol or a copolymer thereof or is a hydroxyl group, wherein said polyethylene glycol has a weight averaged molecular weight of about 150 D to about 10,000 D.

7. (canceled)

8. The composition of claim 6, further comprising:
a second ester of said agriculturally active compound, said second ester having the formula: 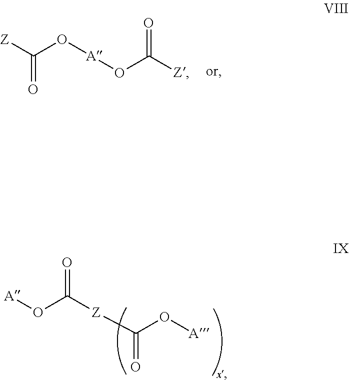
wherein, O-A″-O, A″-O and A′″-O are each a residue of a polyalkylene glycol other than polyethylene glycol (PEG);”
x′ is 0 or 1; and
Z and Z′ are a portion of the agriculturally active compound.

9. (canceled)

10. (canceled)

11. The composition of claim 1, wherein said first polyol and said second polyol are different types of polyol.

12. The composition of claim 1, wherein the ratio of said agriculturally active compound to said ester of said agriculturally active compound is about 0.01:1 to about 0.5:1.

13. The composition of claim 1, wherein said agriculturally active compound I′ or I″ is selected from the group consisting of
a. carboxylic acid containing herbicides;
b. carboxylic acid containing fungicides;
c. pyroglutamic acid;
d. levulinic acid;
e. pamoic acid;
f. ketosuccinamide; and
g. a dicarboxylic acid having the structure: 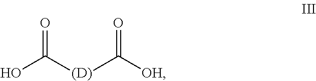
wherein, D is a linear C₁₋₅ alkyl group having at least one carbonyl embedded in the alkyl group.

14. The composition of claim 13 comprising:
i. an agriculturally active compound I′, wherein the agriculturally active compounds is pyroglutamic acid having the structure: 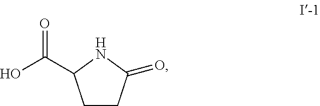
or salts thereof, and
ii. said ester of said agriculturally active compound, wherein the ester is one or more esters of Formula IV: 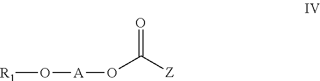
wherein,
O-A-O is a residue of a first polyol;
Z is a 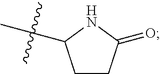 [SMILES: *C1CCC(=O)N1]
and
R₁ is absent or is selected from hydrogen and Q;
wherein, Q is Q¹ and has the structure: 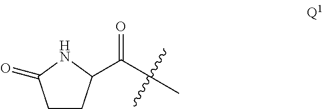
wherein, 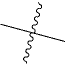
is the point of attachment; or
i. an agriculturally active compound I′, wherein the agriculturally active compounds is levulinic acid having the structure: 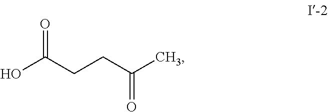
or salts thereof, and
ii. said ester of said agriculturally active compound, wherein the ester is an ester of Formula IV: 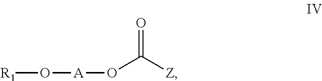
wherein,
O-A-O is a residue of a first polyol;
Z is 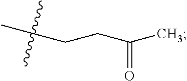 [SMILES: *CCC(C)=O]
and
R₁ is absent or is selected from hydrogen and Q;
wherein, Q is Q² and has the structure: 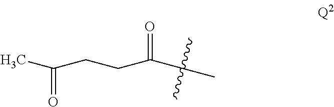
wherein, 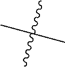
is the point of attachment;
or
i. an agriculturally active compound I′, wherein the agriculturally active compounds is ketosuccinimate having the structure: 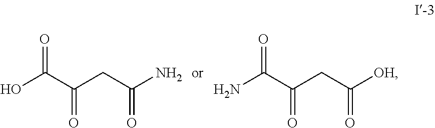 [SMILES: NC(=O)CC(=O)C(=O)O ; NC(=O)C(=O)CC(=O)O]
or salts thereof, and
ii. said ester of said agriculturally active compound, wherein the ester is an ester of Formula IV: 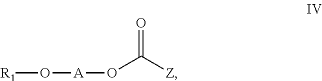
wherein,
O-A-O is a residue of a first polyol;
Z is 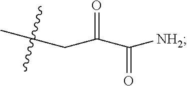 [SMILES: *CC(=O)C(N)=O]
R₁ is absent or is selected from hydrogen and Q;
wherein, Q is Q³ and has the structure: 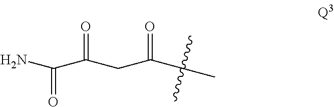
wherein, 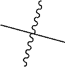
is the point of attachment; and
an agriculturally acceptable carrier.

15. The composition of claim 14, wherein the agriculturally active compound is pyroglutamic acid, and said ester of pyroglutamic acid comprises one or more esters of pyroglutamic acid esters selected from the group consisting of Formulae V-VII: 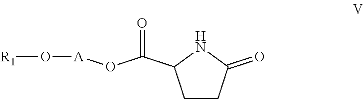
or salts thereof, wherein
O-A-O is a residue of a linear or branched polyalkylene glycol or oligomer or dendrimer thereof, and R₁ is absent or is selected from the group consisting of hydrogen and Q¹; 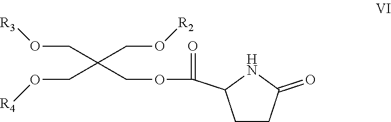
or salts thereof, wherein,
R₂, R₃ and R₄, in each instance, is independently selected from the group consisting of hydrogen and Q¹; 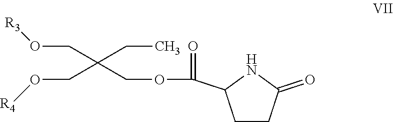
or salts thereof, wherein,
R₃ and R₄, in each instance, is independently selected from the group consisting of hydrogen and Q¹.

16. (canceled)

17. The composition of claim 15, wherein the residue of a linear or branched polyalkylene glycol or oligomer or dendrimer thereof is a residue of PEG or PPG.

18. The composition of claim 14, wherein the ester is of Formula Va: 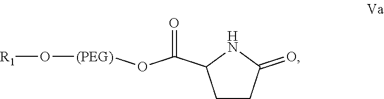
wherein, O-PEG-O is a residue of PEG; R₁ is selected from hydrogen and Q.

19. (canceled)

20. The composition of claim 18, wherein about 10% to about 90% of R₁ is Q and the remainder of R₁ is hydrogen.

21. The composition of claim 15, comprising a mixture of esters of pyroglutamic acid, the mixture comprising Formulae V and VI; Formulae V and VII; Formulae VI and VII; and Formula V, VI and VII.

22. (canceled)

23. (canceled)

24. The composition of claim 13, wherein said agriculturally active compound I or I′ is:
g. a dicarboxylic acid having the structure: 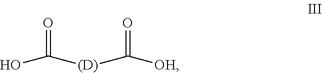
wherein D is

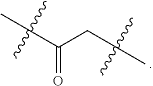 [SMILES: *CC(*)=O]

25. The composition of claim 24, wherein the ester of said agriculturally active compound has the Formula IIa′: 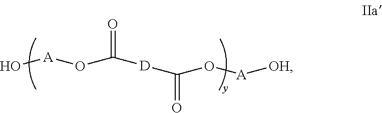
wherein, D is

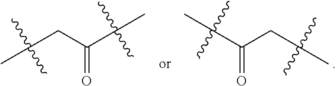 [SMILES: *CC(*)=O ; *CC(*)=O]

26. The composition of claim 25, wherein O-A and O-A-OH, in each instance, is: a residue of a polyalkylene glycol; and/or
residue of a different polyalkylene glycol; and/or
a residue of tetraethylene glycol; and/or
a residue of tetraethylene glycol having the structure:

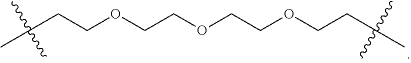 [SMILES: *CCOCCOCCOCC*]

27. The composition of claim 1, wherein from about 50% to about 100% of the ester of said agriculturally active compound is hydrolyzed and/or released over a period of about 50 days or less after the composition is contacted with the plant or area adjacent to the plant.

28. (canceled)

29. The composition of claim 1, wherein said agriculturally active compound I′ or I″ is a herbicide selected from the group consisting of cambendichlor, chloramben, dicamba, 2,3,6-TBA, tricamba and carboxylic acid analogs thereof, byspyribac and pyriminobac and carboxylic acid analogs thereof, aminopyralid, clopyralid, florpyrauxifen, halauxifen and picloram, quinclorac, quinmerac, clacyfos, 4-CPA, 2,4-D, 3,4-DA, MCPA, MCPA-thioethyl, and 2,4,5-T, cloprop, 4-CPP, dichlorprop, dichlorprop-P, 3,4-DP, fenoprop, mecoprop, and mecoprop-P, chlorazifop, clodinafop, cyhalofop, diclofop, fenoxaprop, fenoxaprop-P, fenthiafop, fluazifop, fluazifop-P, haloxyfop, haloxyfop-P, isoxapyrifop, kuicaoxi, metamifop, propaquizafop, quizalofop, quizalofop-P, trifop, and endothal.

30. (canceled)

31. The composition of claim 1, wherein said agriculturally active compound I′ or I″ is a fungicide selected from the group consisting of benalaxyl, benalaxyl-M, furalaxyl, metalaxyl, metalaxyl-M, pefurazoate, valifenalate and carboxylic acid analogs thereof, blasticidin-S, kasugamycin, natamycin, polyoxorim, azoxystrobin, bifujunzhi, coumoxystrobin, enoxastrobin, flufenoxystrobin, jiaxiangjunzhi, picoxystrobin, pyraoxystrobin, cloquintocet, fenchlorazole, isoxadifen, mefenpyr, megatomoic acid and carboxylic acid analogs thereof and salts thereof.

32. An article comprising a composition of claim 1 having an engineered three-dimensional shape, wherein the shape is selected from the group consisting of a rod, a spike, a block, and an orb.

33. (canceled)

34. A method for improving plant properties comprising:
contacting the plant or area adjacent to the plant with an effective amount of a composition of claim 1,
wherein improving plant properties comprises one or more of: increasing growth rate, increasing nodulation, increasing the percent dry weight of the plant, and/or increasing fresh weight.

35. (canceled)

36. (canceled)

37. (canceled)

38. (canceled)

39. (canceled)

40. (canceled)

41. (canceled)

42. (canceled)

43. (canceled)

44. A method for improving resistance to pests comprising contacting the area adjacent to the plant with a composition of claim 1.

45.-48. (canceled)
